(19) United States
(12) Patent Application Publication
(10) Pub. No.: US 2006/0140228 A1
(43) Pub. Date: Jun. 29, 2006

(54) Semi-integrated designs with in-waveguide mirrors for external cavity tunable lasers

(76) Inventors: Mark E. McDonald, Milpitas, CA (US); John M. Hutchinson, Santa Barbara, CA (US); Sergei Sochava, Sunnyvale, CA (US); Dmitri E. Nikonov, Morgan Hill, CA (US); William B. Chapman, Sunnyvale, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/023,711

(22) Filed: Dec. 28, 2004

(51) Int. Cl. H01S 3/10

(52) U.S. Cl. 372/20; 372/26

(57) ABSTRACT

Semi-integrated external cavity diode laser (ECDL) designs including integrated structures comprising a gain section, modulator section, and optional phase control section. Each integrated structure includes a waveguide that passes through each of the sections, with the waveguide further including an in-waveguide mirror. The in-waveguide mirror defines one end of an “effective” laser cavity, with the other end defined by a reflective element disposed generally opposite a rear facet of the integrated structure, forming an external cavity therebetween. The in-waveguide mirror is formed by using a focused ion beam (FIB) cut through the waveguide, or by etching one or more trenches through the waveguide and backfilling the trenches using a re-grown crystal or amorphous material deposition process. A tunable filter is disposed in the external cavity to effectuate tuning of the laser. The modulation section of the integrated structure enables high-speed modulation of an optical signal at a selected communication channel without requiring an external modulator.

### FIELD OF THE INVENTION

The field of invention relates generally to optical communication systems and, more specifically but not exclusively relates to enhanced tunable lasers and methods for laser apparatuses that provide enhanced tuning via semi-integrated designs with in-line (within waveguide) mirrors.

### BACKGROUND INFORMATION

There is an increasing demand for tunable lasers for test and measurement uses, wavelength characterization of optical components, fiberoptic networks and other applications. In dense wavelength division multiplexing (DWDM) fiberoptic systems, multiple separate data streams propagate concurrently in a single optical fiber, with each data stream created by the modulated output of a laser at a specific channel frequency or wavelength. Presently, channel separations of approximately 0.4 nanometers in wavelength, or about 50 GHz are achievable, which allows up to 128 channels to be carried by a single fiber within the bandwidth range of currently available fibers and fiber amplifiers. Greater bandwidth requirements will likely result in smaller channel separation in the future.

DWDM systems have largely been based on distributed feedback (DFB) lasers operating with a reference etalon associated in a feedback control loop, with the reference etalon defining the ITU wavelength grid. Statistical variation associated with the manufacture of individual DFB lasers results in a distribution of channel center wavelengths across the wavelength grid, and thus individual DFB transmitters are usable only for a single channel or a small number of adjacent channels.

Continuously tunable external cavity lasers have been developed to overcome the limitations of individual DFB devices. Various laser-tuning mechanisms have been developed to provide external cavity wavelength selection, such as mechanically tuned gratings used in transmission and reflection. External cavity lasers must be able to provide a stable, single mode output at selectable wavelengths while effectively suppress lasing associated with all other external cavity modes that are within the gain bandwidth of the cavity. These goals have been difficult to achieve, and there is accordingly a need for an external cavity laser that provides stable, single mode operation at selectable wavelengths.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1a is a schematic diagram of a generalized external cavity laser for which various embodiments of the invention may be derived in accordance with the teachings and principles disclosed herein;

FIG. 1b is a schematic diagram illustrating a laser cavity defined by a partially-reflective front facet of a Fabry-Perot gain chip and a reflective element;

FIG. 2 is a diagram illustrating a relative position of a laser cavity's lasing modes with respect to transmission peaks defined by an intra-cavity etalon and channel selector;

FIG. 3a is a schematic diagram illustrating a first exemplary semi-integrated external-cavity diode laser (ECDL) configuration including an integrated structure having gain, and modulator sections that are optically-coupled via a tilted waveguide having an in-waveguide mirror formed using a focused ion beam (FIB) cut, according to one embodiment of the invention;

FIG. 3b is a schematic diagram illustrating an optional configuration for the integrated structure of FIG. 3a, further including a phase control section that replaces the external phase control element;

FIG. 3c is a schematic diagram illustrating a second exemplary semi-integrated ECDL configuration including an integrated structure having gain and modulator sections that are optically-coupled via a bent waveguide having an in-waveguide mirror formed using an FIB cut, according to one embodiment of the invention;

FIG. 3d is a schematic diagram illustrating an optional configuration for the integrated structure of FIG. 3c, further including a phase control section that replaces the external phase control element;

FIG. 3e is a schematic diagram illustrating a third exemplary semi-integrated ECDL configuration including an integrated structure having gain and modulator sections that are optically-coupled via a bent waveguide having an in-waveguide mirror formed using one or more backfilled trenches, according to one embodiment of the invention;

FIG. 3f is a schematic diagram illustrating an optional configuration for the integrated structure of FIG. 3e, further including a phase control section that replaces the external phase control element;

FIG. 3g is a schematic diagram illustrating a fourth exemplary semi-integrated external-cavity diode laser (ECDL) configuration including an integrated structure having gain and modulator sections that are optically-coupled via a tilted waveguide having an in-waveguide mirror formed using one or more backfilled trenches, according to one embodiment of the invention;

FIG. 4a is a schematic diagram illustrating further details of the integrated structure of FIG. 3a;

FIG. 4b is a schematic diagram illustrating further details of the integrated structure of FIG. 3b;

FIG. 4c is a schematic diagram illustrating further details of the integrated structure of FIG. 3c;

FIG. 4d is a schematic diagram illustrating further details of the integrated structure of FIG. 3d;

FIG. 4e is a schematic diagram illustrating further details of the integrated structure of FIG. 3e;

FIG. 4f is a schematic diagram illustrating further details of the integrated structure of FIG. 3f;

FIG. 4g is a schematic diagram illustrating further details of the integrated structure of FIG. 3g;

FIG. 4h is a schematic diagram illustrating further details of the integrated structure of FIG. 3h;

FIG. 4i is a schematic diagram illustrating an optional configuration for the integrated structure of FIG. 4f, wherein the phase control section is disposed between the gain section and the mirror section;

FIG. 4j is a schematic diagram illustrating an optional configuration for a backfilled mirror structure that further includes an angled mirror that is used to split off a portion of the beam passing through the waveguide and redirect it towards an photo-electronic device, according to one embodiment of the invention;

FIG. 5a is a labeled image derived from a scanning electron microscope showing a cross-section of an FIB cut formed in a ridge waveguide structure;

FIG. 5b is a schematic diagram illustrating a cross-section of an exemplary ridge waveguide structure;

FIG. 6a is a schematic diagram of a mirror section of an integrated structure showing a cross-section configuration of the structure after four trenches have been etched in a waveguide core;

FIG. 6b is a schematic diagram illustrating the configuration of the integrated structure of FIG. 6a after the trenches have been backfilled and the waveguide ridge has been re-grown;

FIG. 7 is a schematic diagram of a mirror section of an integrated structure that is formed using a second back-filling technique, wherein amorphous backfill material is formed over the structure including the trenches using sputtering, electron-beam evaporation, or chemical vapor deposition;

FIGS. 8a-d show various cross-sections of a mirror section of an integrated structure formed using a third back-filling technique, according to one embodiment of the invention.

FIG. 9 is a table showing various materials and parameters for forming an in-waveguide mirror using the process illustrating in FIG. 7.

FIG. 10 is a diagram illustrating the effect modulating the optical path length of the laser cavity has on the frequency of the lasing mode and the modulation of the laser's output intensity;

FIG. 11 is a diagram illustrating how a modulated excitation input signal and a resulting response output signal can be combined to calculate a demodulated error signal;

FIG. 12 is a schematic diagram illustrating the semi-integrated ECDL of FIG. 3F and further including control system elements (for the purpose of illustration, the integrated structure 302F is not shown in its proper orientation);

FIG. 12a is a schematic diagram illustrating further details of the semi-integrated ECDL of FIG. 12 (for the purpose of illustration, the integrated structure 302F is not shown in its proper orientation);

FIG. 12b is a schematic diagram illustrating an optional configuration for the semi-integrated ECDL of FIG. 12a that employs the integrated structure of FIG. 4j including an in-waveguide angled mirror;

FIG. 13 is a schematic diagram of a digital servo control system for generating an excitation signal to drive a phase control section to produce a laser output including an intensity modulation that is detected and employed as a feedback signal for wavelength locking; and

FIG. 14 is a schematic diagram of a communication network including a network switch in which tunable ECDLs in accordance with embodiments of the invention may be deployed.

### DETAILED DESCRIPTION OF PREFERRED EMBODIMENTS

Embodiments of laser apparatuses that employ a semi-integrated designs including integrated structures with in-waveguide mirrors and methods for manufacturing the integrated structures are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The embodiments of the present invention described below employ a semi-integrated design for tunable lasers, such as external cavity tunable lasers. In order to better understand and appreciate aspects of these embodiments, a brief discussion of the operation and design of conventional external cavity tunable lasers is now presented.

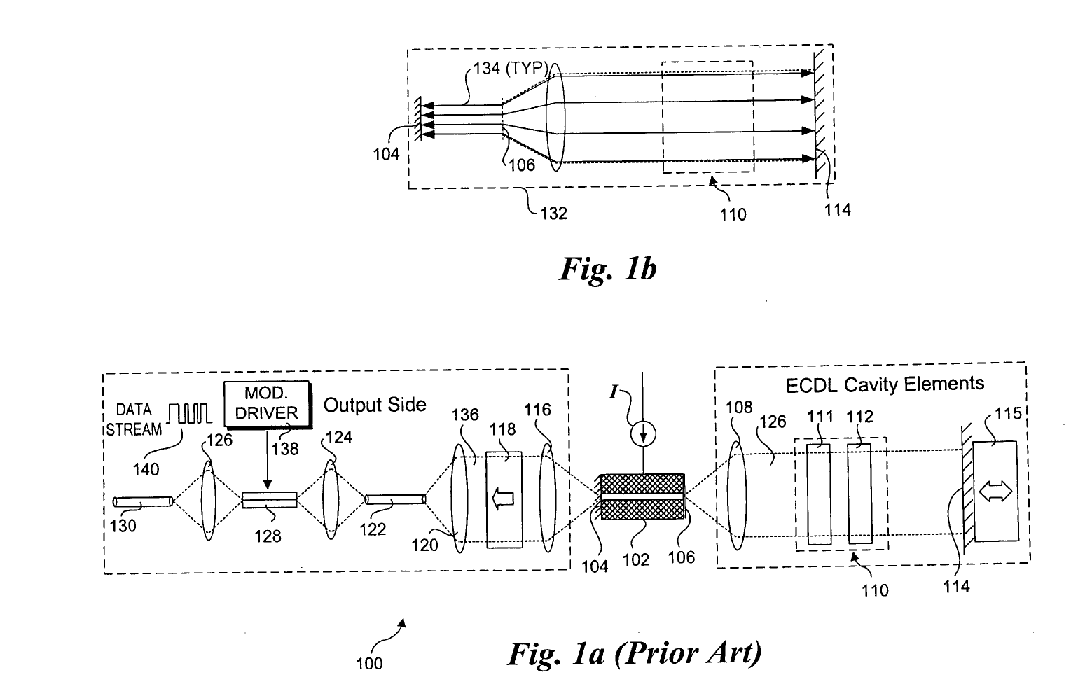

Discrete wavelength tunable diode lasers typically comprise a semiconductor gain medium, two reflectors, and an intra-cavity tuning mechanism. For example, as an overview, a generalized embodiment of an external cavity diode laser (ECDL) 100 configured for optical communication is shown in FIG. 1a. ECDL 100 includes a gain medium comprising a diode gain chip 102. Diode gain chip 102 comprises a Fabry-Perot diode laser including a partially-reflective front facet 104 and a substantially non-reflective rear facet 106 coated with an anti-reflective (AR) coating to minimize reflections at its face. Optionally, diode gain chip 102 may comprise a bent-waveguide structure on the gain medium to realize the non-reflective rear facet 106 (not shown). The external cavity elements include a diode intracavity collimating lens 108, tuning filter element or elements 110 (e.g., etalons 111 and 112), and a reflective element 114. In general, reflective element 114 may comprise a mirror, grating, prism, or other reflector or retroreflector that may also provide the tuning filter function in place of tuning element 110. Also depicted as an ECDL cavity element is a pathlength modulation element 115. This element, which typically comprises a mechanical or thermal actuator, or an electro-optical element, is employed to modulate (dither) the optical pathlength of the laser cavity to induce a perturbation from which an error signal can be derived, as described below in further detail.

In addition to the ECDL cavity elements, a conventional communication laser of this type employs several output side elements used for isolation and data modulation. The output side elements illustrated in FIG. 1a include a diode output collimating lens 116, an optical isolator 118, a fiber focusing lens 120, a fiber pigtail 122 a pair of coupling lenses 124 and 126, a modulator 128 and an output fiber segment 130.

The basic operation of ECDL 100 is a follows. A controllable current I is supplied to diode gain chip 102 (the gain medium), resulting in a voltage differential across the diode junction, which produces an emission of optical energy (photons). (As depicted in the Figures herein, currents and voltages are shown as applied to the top and bottom of the structures for convenience. In practice, the currents and voltages are applied across planes that are parallel to the page plane.) The emitted photons pass back and forth between partially-reflective front facet 104 and reflective element 114, which collectively define the ends of an “effective” laser cavity (i.e., the two reflectors discussed above), as depicted by laser cavity 132 in FIG. 1b. As the photons pass back and forth, a plurality of resonances, or “lasing” modes are produced. Under a lasing mode, a portion of the optical energy (photons) temporarily occupies the external laser cavity, as depicted by an intracavity optical beam depicted as light rays 134; at the same time, a portion of the photons in the external laser cavity eventually passes through partially-reflective facet 104.

Light comprising the photons that exit the laser cavity through partially-reflective front facet 104 passes through diode output collimating lens 116, which collimates the light into a light beam 136. The output beam then passes through optical isolator 118. The optical isolator is employed to prevent back-reflected light from being passed back into the external laser cavity, and is generally an optional element. After the light beam passes through the optical isolator, it is launched into fiber pigtail 122 by fiber focusing lens 120. Generally, output fiber 122 may comprise a polarization-preserving type or a single-mode type such as SMF-28.

Through appropriate modulation of the input current (generally for communication rates of up to 2.5 GHz) or through modulation of an external element disposed in the optical path of the output beam (e.g., modulator 128, as shown in FIG. 1a) (for 10 GHz and 40 GHz communication rates), data can be modulated on the output beam to produce an optical data signal. Such a signal may be launched into a fiber and transmitted over a fiber-based network in accordance with practices well known in the optical communication arts, thereby providing very high bandwidth communication capabilities.

FIG. 1a shows an example of an external modulation scheme. Light entering fiber pigtail 122 exits the fiber to form an angular cone having a maximum angle corresponding to the numerical aperture of the fiber. As light passes through coupling lens 124, it is focused toward an input end of modulator 128. Modulator 128 is driven by a modulation driver 138 that causes the transmittance of the modulator 128 to be modulated based on logic levels defined in an input data stream 140. The modulation of the modulator's transmittance causes a modulation in the amplitude of the optical output signal. This, in turn, can be detected at a receiver to extract the data stream.

In other configurations, the modulator comprises a separate component or assembly that is coupled to the output of the laser via a fiber connection. Thus the assembled laser and modulator require separate manufacture operations for each assembly, increasing both the size and cost of the corresponding communications device for which they are employed.

The lasing mode of an ECDL is a function of the total optical path length between the cavity ends (the cavity optical path length); that is, the optical path length encountered as the light passes through the various optical elements and spaces between those elements and the cavity ends defined by partially-reflective front facet 104 and reflective element 114. This includes diode gain chip 102, diode intracavity collimating lens 108, tuning filter elements 110, plus the path lengths between the optical elements (i.e., the path length of the transmission medium occupying the ECDL cavity, which is typically a gas such as air). More precisely, the total optical path length is the sum of the path lengths through each optical element and the transmission medium times the coefficient of refraction for that element or medium.

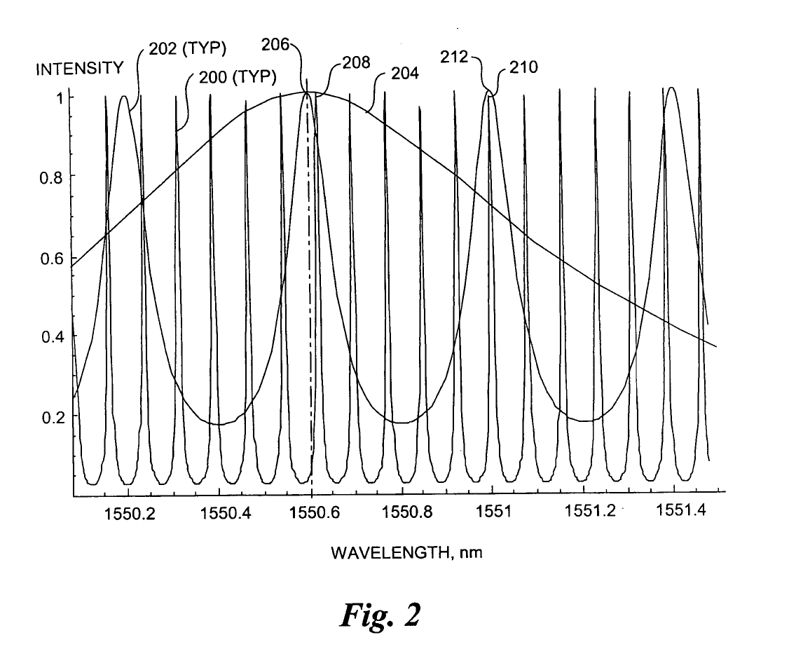

As discussed above, under a lasing mode, photons pass back and forth between the cavity end reflectors at a resonance frequency, which is a function of the cavity optical path length. In fact, without the tuning filter elements, the laser would resonate at multiple frequencies, producing a multi-mode output signal. Longitudinal laser modes occur at each frequency where the roundtrip phase accumulation is an exact multiple of 2π. For simplicity, if we model the laser cavity as a Fabry-Perot cavity, these frequencies can be determined from the following equation:

$$L = \frac{λ x}{2 n} \qquad ( 1 )$$

where λ=wavelength, L=optical length of the cavity, x=an arbitrary integer—1, 2, 3, . . . , and n=refractive index of the medium. The average frequency spacing can be derived from equation (1) to yield:

$$Δ v = \frac{c}{2 nL} \qquad ( 2 )$$

where ν=c/λ and c is the speed of light. The number of resonant frequencies is determined from the width of the gain spectrum. The corresponding lasing modes for the cavity resonant frequencies are commonly referred to as “cavity modes,” an example of which is depicted by cavity modes 200 in FIG. 2.

Semiconductor laser gain media typically have broad gain spectra and therefore require spectral filtering to achieve single longitudinal mode operations (i.e., operations at a single wavelength or frequency). In order to produce an output at a single frequency, filtering mechanisms are employed to substantially attenuate all lasing modes except for the lasing mode corresponding to the desired frequency. As discussed above, in one scheme a pair of etalons, depicted as a grid generator 111 and a channel selector 112 in FIG. 1, are employed for this filtering operation. A grid generator, which comprises a static etalon that operates as a Fabry-Perot resonator, defines a plurality of transmission peaks (also referred to as passbands) in accordance with equations (1) and (2). Ideally, during operation the transmission peaks remained fixed, hence the term “static” etalon; in practice, it may be necessary to employ a servo loop (e.g., a temperature control loop) to maintain the transmission peaks at the desired location. Since the cavity length for the grid generator is less than the cavity length for the laser cavity, the spacing (in wavelength) between the transmission peaks is greater for the grid generator than that for the cavity modes. A set of transmission peaks 202 corresponding to an exemplary etalon grid generator is shown in FIG. 2. Note that at the peaks of the waveform the intensity (relative in the figure) is a maximum, while it is a minimum at the troughs. Generally, the location and spacing of the transmission peaks for the grid generator will correspond to a set of channel frequencies defined by the communication standard the laser is to be employed for, such as the ITU channels and 0.4 nanometer (nm) spacing discussed above and depicted in FIG. 2. Furthermore, the spacing of the transmission peaks corresponds to the free spectral range (FSR) of the grid generator.

A channel selector, such as an adjustable etalon, is employed to select the lasing mode of the laser output. For illustrative purposes, in one embodiment channel selector 112 may comprise an etalon having a width substantially less than the etalon employed for the grid generator. In this case, the FSR of the channel selector is substantially larger than that of the grid generator; thus the bandpass waveform of the channel selector is broadened, as illustrated by channel selector bandpass waveform 204 having a single transmission peak 206. In accordance with this channel selection technique, a desired channel can be selected by aligning the single transmission peak of the channel selector (e.g. 206) with one of the transmission peaks of the grid generator. For example, in the illustrated configuration depicted in FIG. 2, the selected channel has a frequency corresponding to a laser output having a 1550.6 nm wavelength.

In addition to the foregoing scheme, several other channel selecting mechanisms may be implemented, including rotating a diffraction grating; electrically adjusting a tunable liquid crystal etalon; mechanically translating a wedge-shaped etalon (thereby adjusting its effective cavity length); and “Vernier” tuning, wherein etalons of the same finesses and slightly different FSRs are employed, and a respective pair of transmission peaks from among the transmission peaks defined by the etalons are aligned to select the channel in a manner similar to that employed when using a Vernier scale.

As discussed above, other types of tunable laser designs have been considered and/or implemented. In addition to DFB lasers, these include Distributed Bragg Reflector (DBR) lasers. Both DBR and DFB lasers are considered “integrated” lasers because all of the laser components are integrated in a common component. While this is advantageous for manufacturing, an integrated scheme means tuning is coupled to laser diode operation. This results in lower tuning quality when compared with ECDLs.

For example, DFB lasers have a problem with aging. More specifically, as a DFB laser is used, the characteristics of the gain section change over time. This phenomena is known as “aging.” Aging results in a wavelength shift, since the frequency reference and the active gain section are coupled in one chip. In contrast, the frequency reference (i.e., filter elements) are de-coupled from the gain chip for ECDL's, providing improved frequency stability over time.

Another advantage of ECDLs over DFB lasers is spectral characteristics. The much longer lasing cavity in ECDLs provides very narrow linewidth and very good side-mode suppression ratios.

DBR lasers are very similar to DFB lasers. The major difference is that where DFB lasers have a grating within the active region of the cavity, DBR lasers have a partitioned cavity with the grating in a region that is not active (i.e., amplifying). While this provides some isolation from the chirp effect inherent with DFB designs, the tuning characteristics of tunable DBR lasers still leave much to be desired.

The inherent advantage of the ECDL design over the highly integrated DFB and DBR designs is the fact that the tunable filter of the ECDL is decoupled from the gain region, and therefore can be made very stable. As a result, unlike DFB and DBR lasers, ECDL's may not require external wavelength lockers. The separate tuner in an ECDL may be controlled with essentially no cross-talk to other controlled parameters, such as laser diode current, and this can lead to simplified and more robust tuning algorithms than are typical of fully-integrated tunable lasers.

On the other hand, the lack of integration in the conventional ECDL design leads to additional parts count and makes manufacturing of ECDL more labor-intensive and costly. In addition, phase control of existing ECDL designs is slow with respect to requirements for next-generation fast-tuning lasers.

In addressing the foregoing problems, embodiments of the invention described below employ “semi-integrated” designs that combine the manufacturing benefits of integrated structures while decoupling the tuning and gain functions. Thus, the semi-integrated designs provide the tuning capabilities inherent in the de-coupled ECDL design without the manufacturing complexity and costs of the conventional ECDL design.

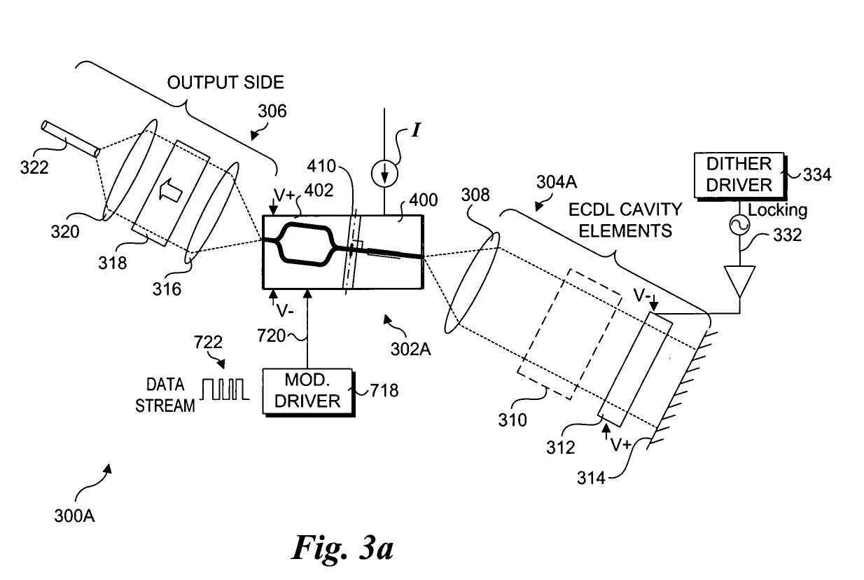

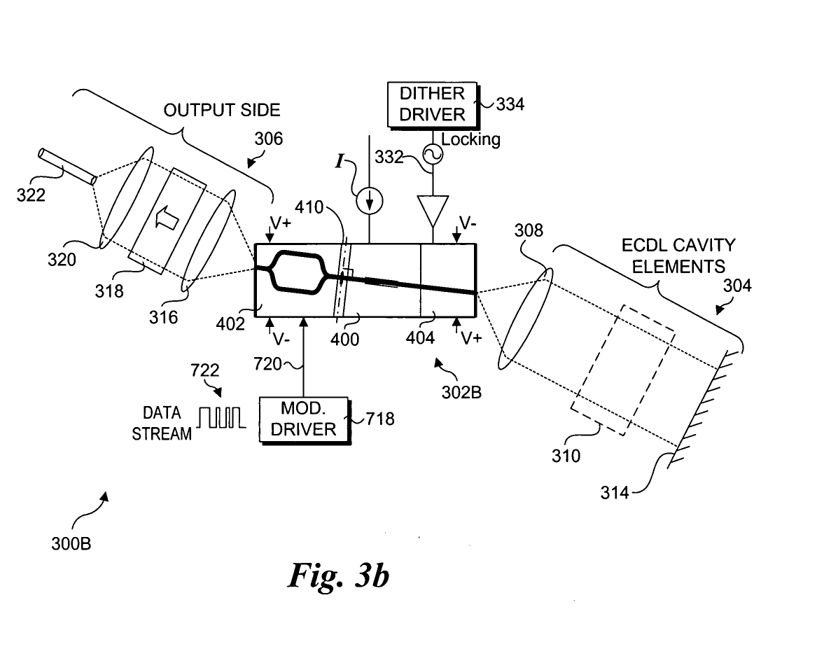

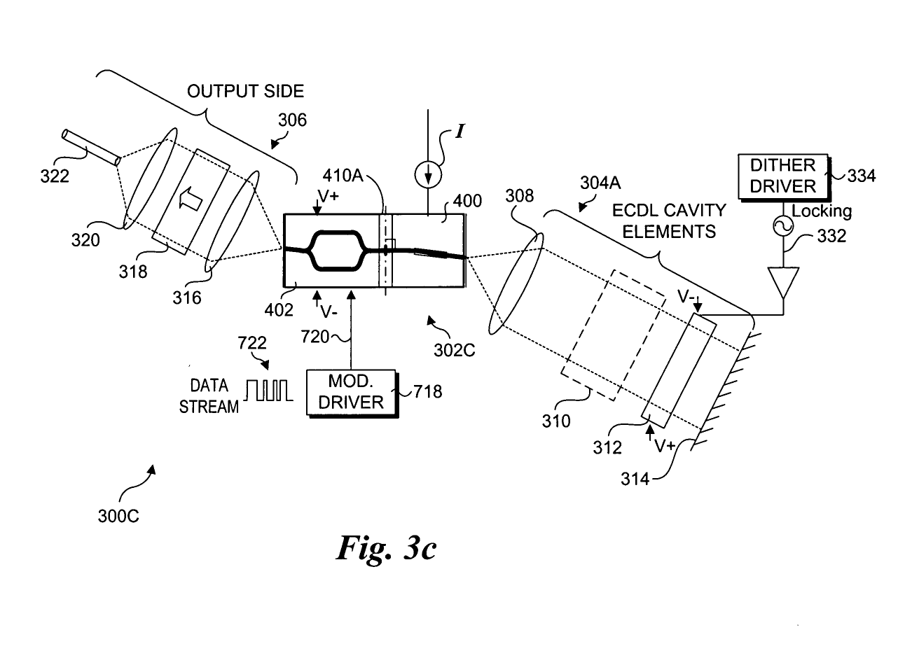

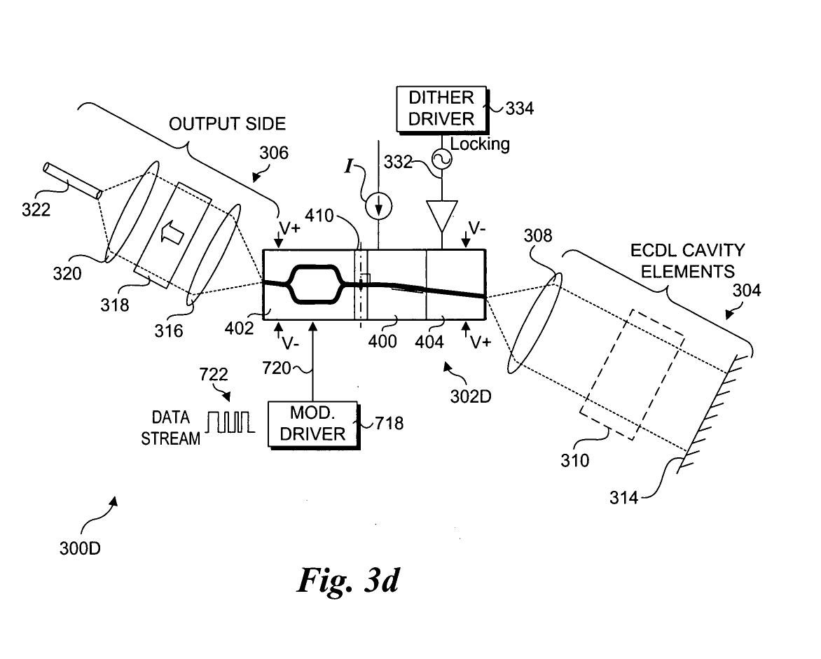

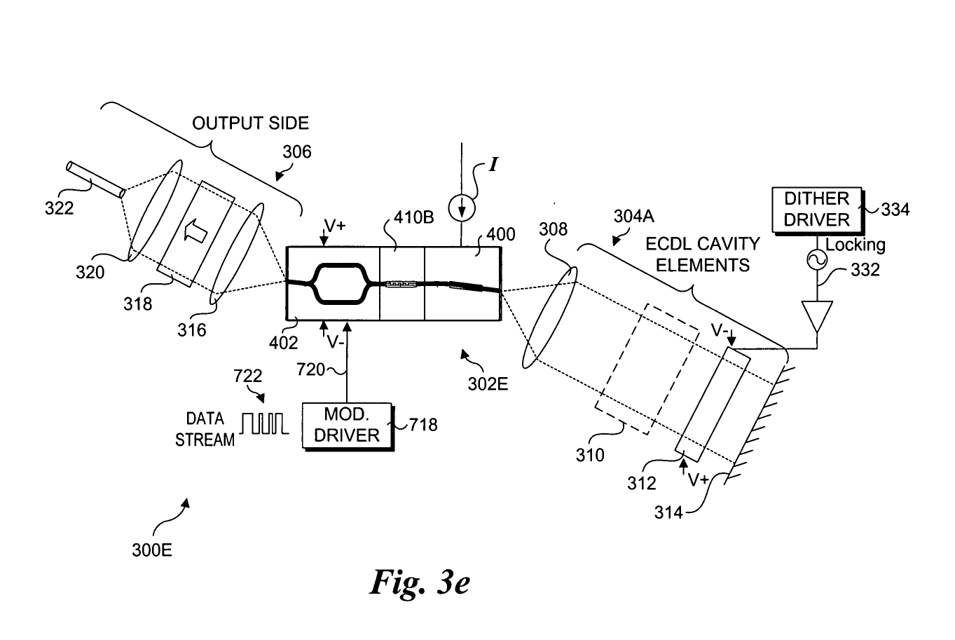

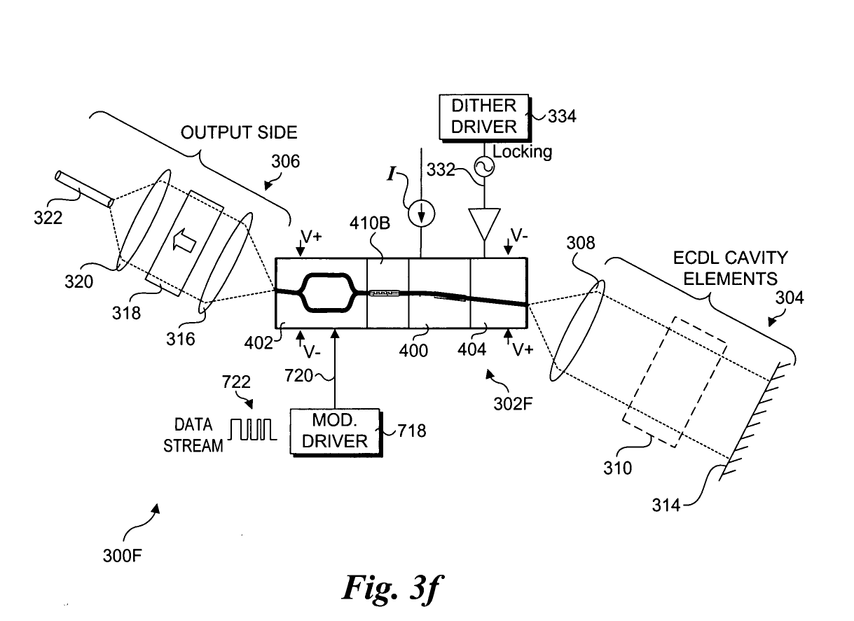

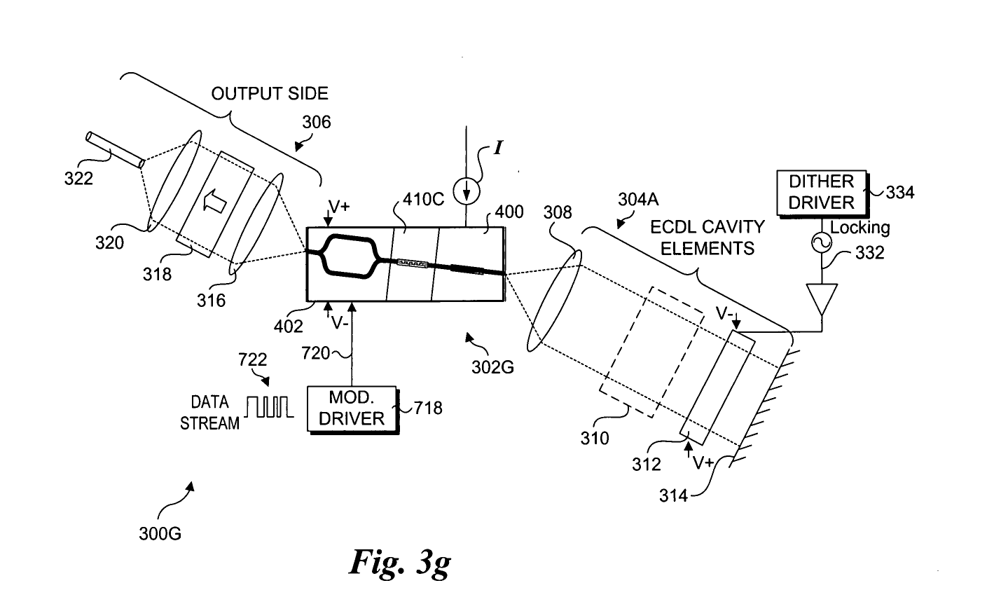

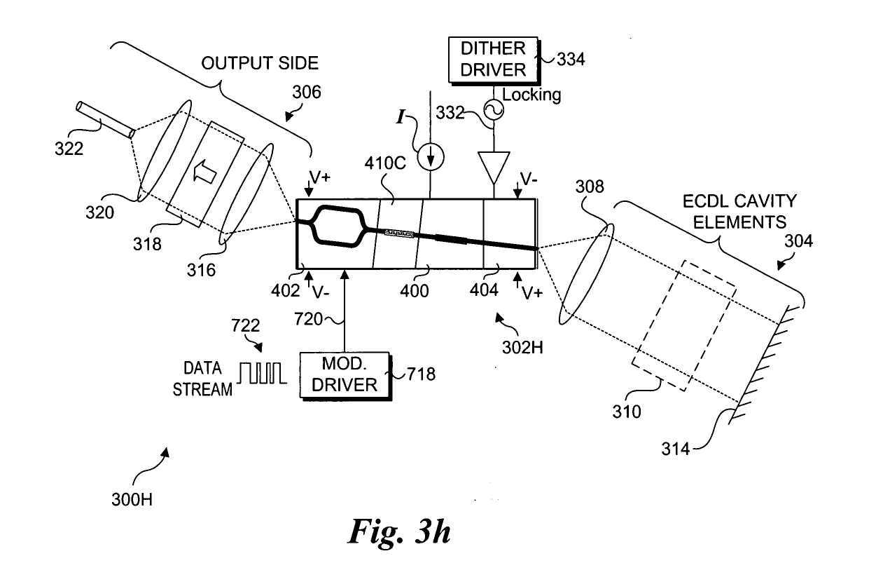

FIGS. 3a and 3b respectively show semi-integrated ECDLs 300A and 300B corresponding to exemplary embodiments of the invention. ECDL 300A includes an integrated structure 302A optically coupled between a set of ECDL cavity elements 304A and a set of output side elements 306. Similarly, ECDL 300B includes an integrated structure 302B optically coupled between a set of ECDL cavity elements 304 and a set of output side elements 306.

In general, the set of ECDL cavity elements 304 will be substantially analogous to those discussed above with reference to FIG. 1a. For example, a typical set of ECDL cavity elements may include a collimating lens 308, a tuning filter element or elements 310, and a reflective element 314. Details of an exemplary tuning filter are discussed below. In general, reflective element 314 may comprise a mirror, grating, prism, or other reflector or retroreflector, which may also provide the tuning filter function in place of tuning filter element 310. ECDL cavity elements 304A of FIG. 3a further include a phase modulator 312.

The output side elements 306 for each of semi-integrated ECDL lasers 302A and 302B are analogous to those described above with reference to FIG. 1a pertaining to the isolation function. These include a collimating lens 316, an optical isolator 318, a fiber focusing lens 320, and an output fiber 322.

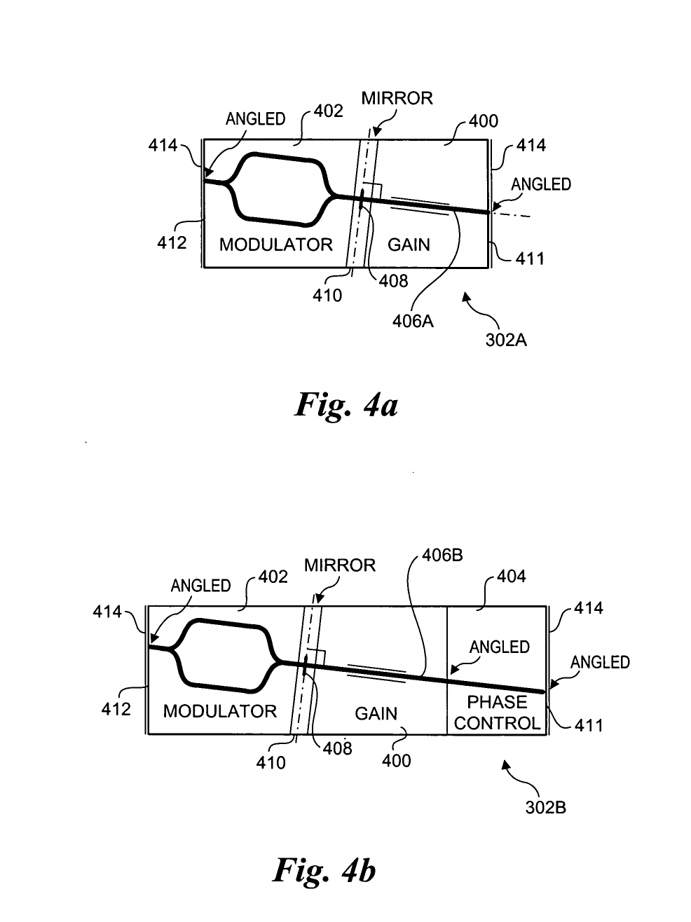

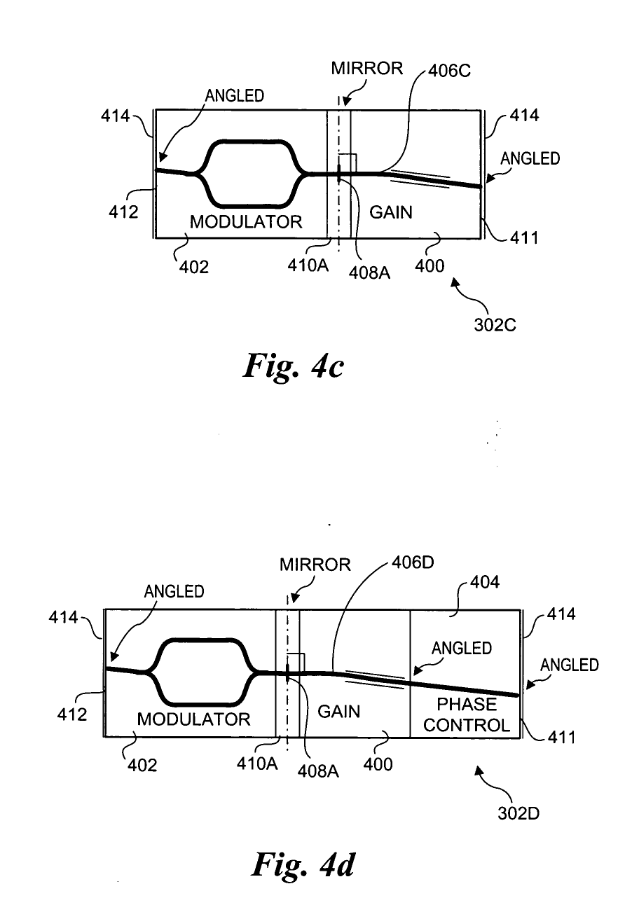

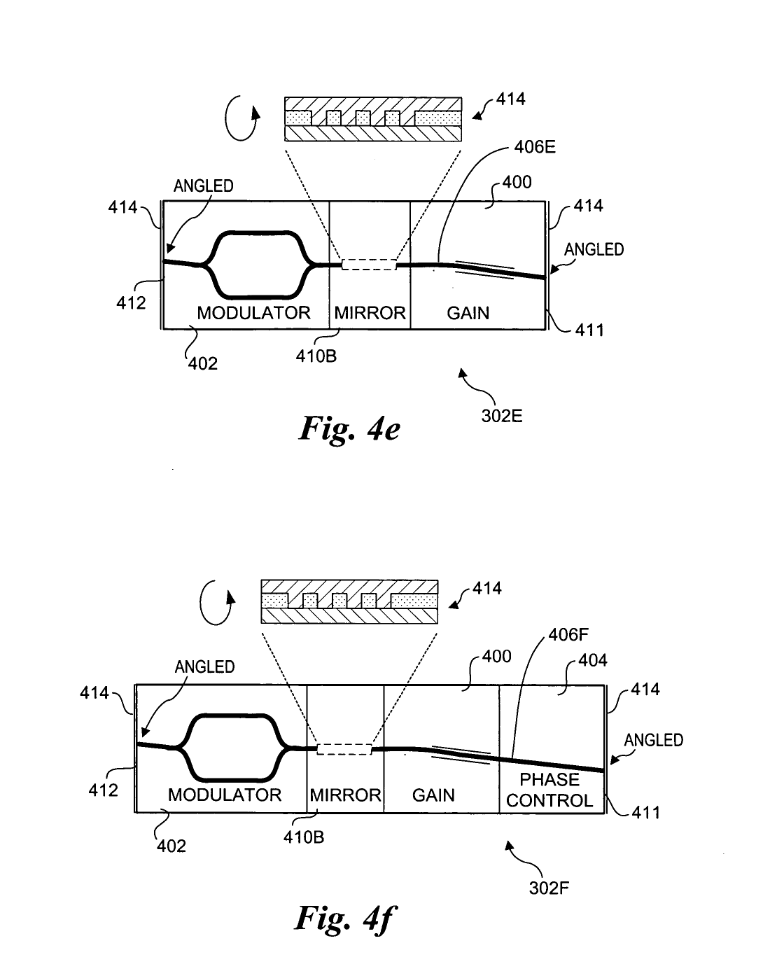

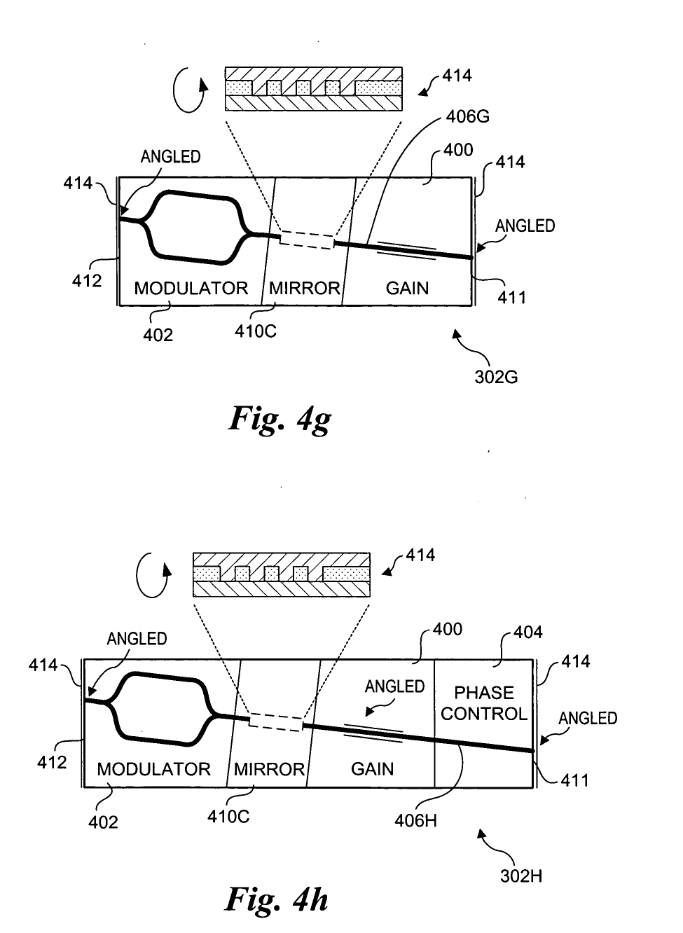

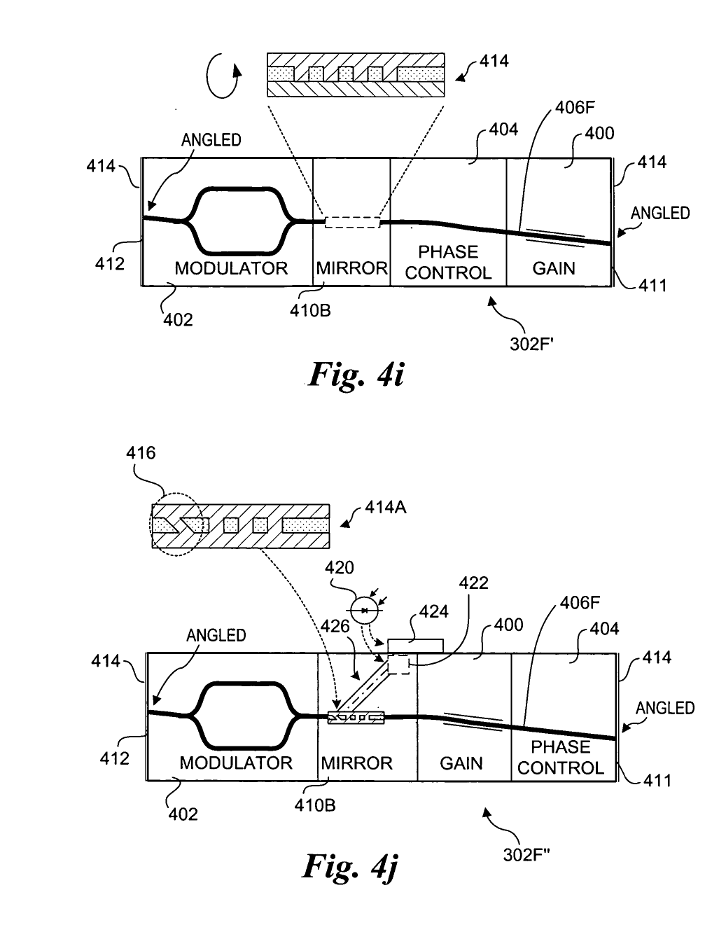

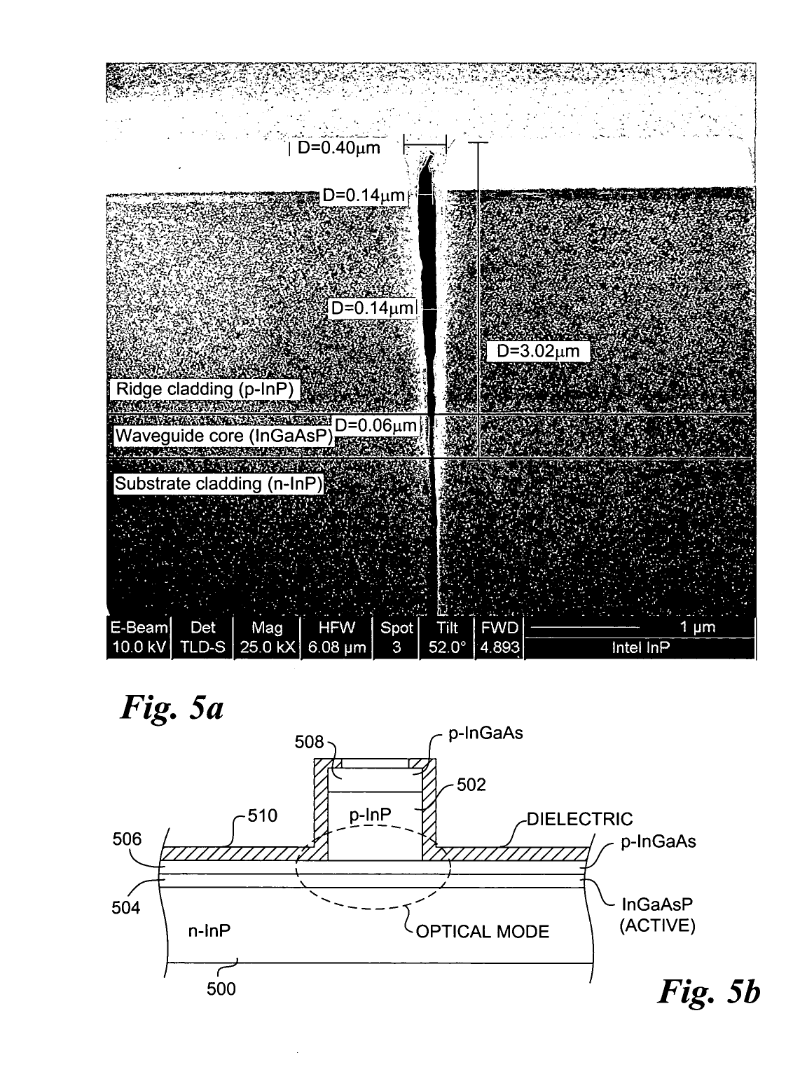

Further details of integrated structures 302A and 302B are shown in FIGS. 4a and 4b, respectively. Each of these integrated structures includes a gain section 400 and a modulator section 402, while integrated structure 302B further includes a phase control section 404. The gain and modulator sections for integrated structure 302A are optically coupled via a waveguide 406A, while the phase control, gain, and modulator sections for integrated structure 302B are optically coupled via a waveguide 406B. In each of integrated structures 302A and 302B, a mirror 408 is formed within the waveguide (406A or 406B) in a portion of the waveguide between gain section 400 and modulator section 402. As described in further detail with reference to FIGS. 5a and 5b, mirror 408 is formed by a high-aspect ratio gap defined perpendicular to (a longitudinal axis passing through the core of) waveguides 406A and 406B. For clarity, mirror 408 is shown as being disposed in a mirror section 410, which in practice represents a very short section of waveguide 406A or 406B. It is further noted that the size of the various sections of the integrated structures depicted herein are not to scale and are depicted as shown for clarity, as will be recognized by those skilled in the semiconductor laser art.

Integrated structures 302A and 302B each include a non-reflective front facet 411 and a non-reflective rear facet 412. To make the facets non-reflective, an appropriate anti-reflective coating 414 is applied to each of non-reflective facets 411 and 412 in a manner similar to that discussed above for non-reflective facet 106.

Each of integrated structures 302A and 302B share similar qualities with respect to how waveguides 406A and 406B are configured at the junctions between the phase control (if included), gain, mirror, and modulator sections. In particular, the configuration of waveguides 406A and 406B is configured such that they are angled (i.e., non-perpendicular) relative to each of front and rear facets 411 and 412, and at the junctions between the various sections. Furthermore, integrated structures 302A and 302B employ a tilted waveguide geometry. That is, in this configuration the plane in which mirror 410 is formed is tilted at an angle relative to the crystalline plane structure of the substrate material from which integrated structures 302A and 302B are formed.

FIGS. 3c and 3d respectively show semi-integrated ECDLs 300C and 300D corresponding to further embodiments of the invention. ECDL 300C includes an integrated structure 302C optically coupled between a set of ECDL cavity elements 304A and a set of output side elements 306. Similarly, ECDL 300D includes an integrated structure 302D optically coupled between a set of ECDL cavity elements 304 and a set of output side elements 306.

Further details of integrated structures 302C and 302D are shown in FIGS. 4c and 4d, respectively. As illustrated by like-numbered references, the configuration of integrated structures 302C and 302D are similar to integrated structures 302A and 302B, with each integrated structure including a gain section 400 and a modulator section 402, with integrated structure 302D further including a phase control section 404. Each of integrated structures 302C and 302D include a mirror 408A formed by a perpendicular gap in a portion of respective waveguides 406C and 406D along a portion of the waveguide depicted as a mirror section 410A.

As further depicted in FIGS. 4C and 4D, in contrast to the tilted configuration for waveguides 406A and 406B of integrated structures 302A and 302B, integrated structures 302C and 302D employ a bent waveguide geometry to achieve the similar results, including perpendicularity at the waveguide/mirror interface and non-perpendicular at the waveguide/facet interfaces. In this instance, the mirror plane is parallel to the crystalline plane of the substrate material. To obtain this configuration, portions of waveguides 406C and 406D are bent or radiused.

The angled and perpendicular waveguide/facet interfaces are configured as such to take advantage of well-known optical phenomena. More specifically, the optical phenomena concern the behavior of light as it passes between two materials having different indexes of refraction. Depending on the difference between the refractive indexes and angle of incidence, varying amounts of incident power will be reflected back. In the case of normal incidence, substantially all the reflected light is coupled into the waveguide while in the case of the angled incidence (optimum is about 6 deg) most of the reflected light leaves the waveguide (gets scattered) and therefore does not interact with the cavity light.

With the foregoing optical phenomena in mind, in one embodiment mirrors 408 and 408A are formed by removing or altering a planar portion of material along a portion of their respective waveguides depicted in mirror sections 410 and 410A. This creates a difference between the effective index of refraction of the waveguide material and the index of refraction of the gap material (typically a surrounding gas, such as air). This index of refraction difference along with the perpendicular configuration produces a partial reflection at the gap, resulting in a low reflectivity mirror (i.e., 2-10%). Thus, mirrors 408 and 408A define one of the end reflectors for the effective laser cavity of ECDLs 300A, 300B, 300C, and 300D (as applicable), with the other end of the laser cavity defined by reflective element 314.

In the meantime, it is not desired to have additional mirror elements in the laser cavity. Such elements may produce phase interferences, among other problems. Therefore, the angle of waveguides 406A-D are selected to be non-perpendicular at front and rear facets 411 and 412. In practice, a small portion of light is reflected at the interface plane between materials having dissimilar refractive indexes when the waveguide is tilted or bent. However, the angle tilt with respect to the facet planes provides mode mismatch for the reflected light, and thus prevents interference with the lasing mode to which the laser is tuned.

In one embodiment, mirror 408 or 408A may be formed by using a focused ion beam (FIB). FIB systems operate in a similar fashion to a scanning electron microscope (SEM) except, rather than using a beam of electrons, FIB systems use a finely focused beam of gallium or other ions that can be operated at low beam currents for imaging or high beam currents for site specific sputtering or milling.

The results of an exemplary FIB milling process that is employed to form a 0.06 micrometer (μm) gap in the ridge waveguide of an integrated structure 302 is shown in FIG. 5a, while an exemplary ridge waveguide structure is shown in FIG. 5b. Both structures include substrate cladding 500 comprising n-doped InP, a ridge cladding 502 comprising p-doped InP, and a waveguide core 504 comprising a layer of InGaAs. As shown in FIG. 5B, a typical ridge waveguide structure may further include a p-doped layer of InGaAsP formed above the InGaAsP waveguide layer, and a p-doped layer of InGaAs 506 disposed above the ridge cladding 508. A dielectric layer 510 may be formed over the top of the structure to insulate and protect the underlying layers.

FIB systems employ a sputtering technique for performing machining of substrates. The gallium (Ga⁺) primary ion beam hits the substrate surface and sputters a small amount of material, which leaves the surface as either secondary ions (i⁺ or i⁻) or neutral atoms (n⁰). The primary beam also produces secondary electrons (e⁻). At low primary beam currents, very little material is sputtered; under this type of operation, an FIB system may be used for imaging, and can achieve 5 nm imaging resolution. At higher primary currents, a great deal of material can be removed by sputtering, allowing precision milling of the specimen down to a sub-micron scale.

FIB systems are able to produce material “cuts” with very-high aspect ratios (cut depth vs. width). However, the sputtering technique does not produce a perfect high-aspect ratio cut. Rather, a kerf is formed, having a greater width at the top of the cut, with the kerf becoming narrower with increasing depth. Ideally, the sidewalls formed by the FIB cut should be (substantially) perpendicular proximate to the section of the cut passing through the waveguide, although some imperfections are tolerable.

Another technique for producing an in-waveguide mirror is to define one or more low-aspect ratio “trenches” through the core of the waveguide, and then backfill the trenches with a material having an appropriate (selectable) index of refraction. As discussed in further detail below, the number of trenches will generally be dependent on the selected backfill material in view of the desired level of reflectivity to be obtained and the waveguide geometry.

FIGS. 3e-h show respective embodiments of semi-integrated ECDLs 300E-H that employ an in-waveguide mirror formed using one or more low-aspect ratio back-filled trenches. Details of the integrated structures corresponding to the ECDLs 300E-H are shown in FIGS. 4e-h, respectively. In general, the overall configuration of the ECDLs and integrated structures are similar to those shown in FIGS. 3a-d and 4a-d and discussed above, wherein components having like-numbered references perform similar functions. The primary difference between the sets of embodiments is that the embodiments shown in FIGS. 3e-h and 4e-h employ one or more backfilled trenches rather than a single FIB cut.

In further detail, FIGS. 4e and 4f respectively show bent waveguide integrated structures 302E and 302F, each of which include a mirror section 410B disposed between a gain section 400 and a modulator section 402. Integrated structure 302F further includes a phase control section 404. A backfilled trench mirror structure 414 is defined in a portion of bent waveguides 406E and 406F depicted by mirror section 410B.

FIGS. 4g and 4h respectively show tilted waveguide integrated structures 302G and 302H, each of which include a mirror section 410C disposed between a gain section 400 and a modulator section 402. As before, a backfilled trench mirror structure 414 is defined in a portion of tilted waveguides 406G and 406H depicted by mirror section 410C.

There are various techniques that may be employed to form the backfilled trench mirror structure of the embodiments of the integrated structures 302E-H shown in FIGS. 4E-H. In general, the processes for forming the structure will include a material removal process to form the trenches in the portion of the waveguide defining the mirror section, followed by a material addition (re-growth or deposition) to backfill the trenches, wherein the backfill material is selected to have an index of refraction that differs from the refractive index of the waveguide core material.

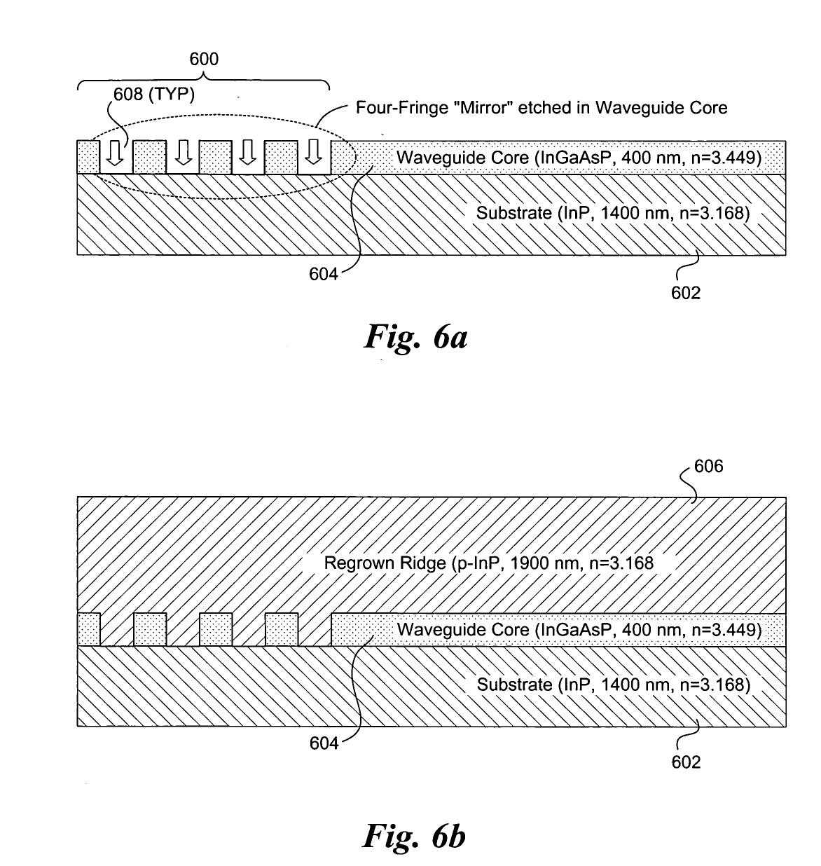

In one embodiment, the trenches are formed using well-known etching techniques. In order to provide good etch quality, a low aspect ratio etch geometry is employed. For example, an etch geometry having an aspect ratio of approximately 1:1 is shown in FIGS. 6a and 6b. In one embodiment, the width of the trenches is approximately ¾λ/n, wherein λ represents the “nominal” wavelength of the laser (it is recognized that the actual laser wavelength of a tunable laser implementing the mirror structure will change a small amount in view of tuning parameters, hence the use of the term “nominal” here) and n is the refractive index of the backfill material.

The difference between the refractive indexes of the waveguide material and backfill material should be sufficient to obtain a combined reflectivity of approximately 10%. Generally, a greater difference in the refractive indexes will produce greater reflectivity and will therefore require a lower number of trenches. A typical waveguide core material has an index of refraction of approximately 3.3. For instance, InGaAsP has a refractive index n=3.449. In view of this typical value, it is recommended that the refractive index of the backfill material should be less than 3.

Another consideration is diffractive losses. Unlike the FIB cut approach, the width of each trench is significant compared with the light wavelength. The trench portions of the structure no longer perform in the same manner as the non-trenched waveguide portions, leading to diffractive losses out the “sides” of the trenches. To minimize diffractive losses, it is generally recommended that backfill materials having refractive indexes of >2 be used. In view of the index difference and diffraction considerations, it is thus recommended that 2<n<3 for the trench backfill material.

A further consideration pertains to spectral response. The spectral response is related to the length of the portion of the waveguide containing the back-filled trench mirror structure. In general, the shorter this portion is, the flatter the spectral response. In one embodiment, the ECDLs that employ the back-filled trench mirror structure are designed to produce communication signals for C-band or L-band transmissions. In this instance, the total mirror length should be under approximately 3 microns to provide flat spectral response across the C- or L-band channels.

In one embodiment, the backfill material comprises re-grown InP. With reference to FIG. 6a, one embodiment of a process for forming a back-filled trench mirror structure begins by growing an InP wafer with offset quantum wells (as described below) and etch away quantum wells for the mirror section 600. In the illustrated embodiment, the structure includes an InP substrate 602 and an InGaAsP waveguide core 604, which is formed using well-known semiconductor manufacturing techniques. Depending on the backfill material to be employed, one or more low-aspect ratio trenches are etched through the waveguide core; these are depicted as four trenches 608 in the illustrated embodiment. In one embodiment, the waveguide core has a thickness of approximately 400 nanometers (nm), while the width of the trenches is approximately. 370-470 nm, depending on the refractive index of the backfill material.

After the trenches have been formed, a process is employed to re-grow p-InP over the trenches and about two microns above the waveguide core to form the upper cladding layer for the waveguide, as shown in FIG. 6b. Selective portions of the p-InP cladding layer are then further etched to form the ridge.

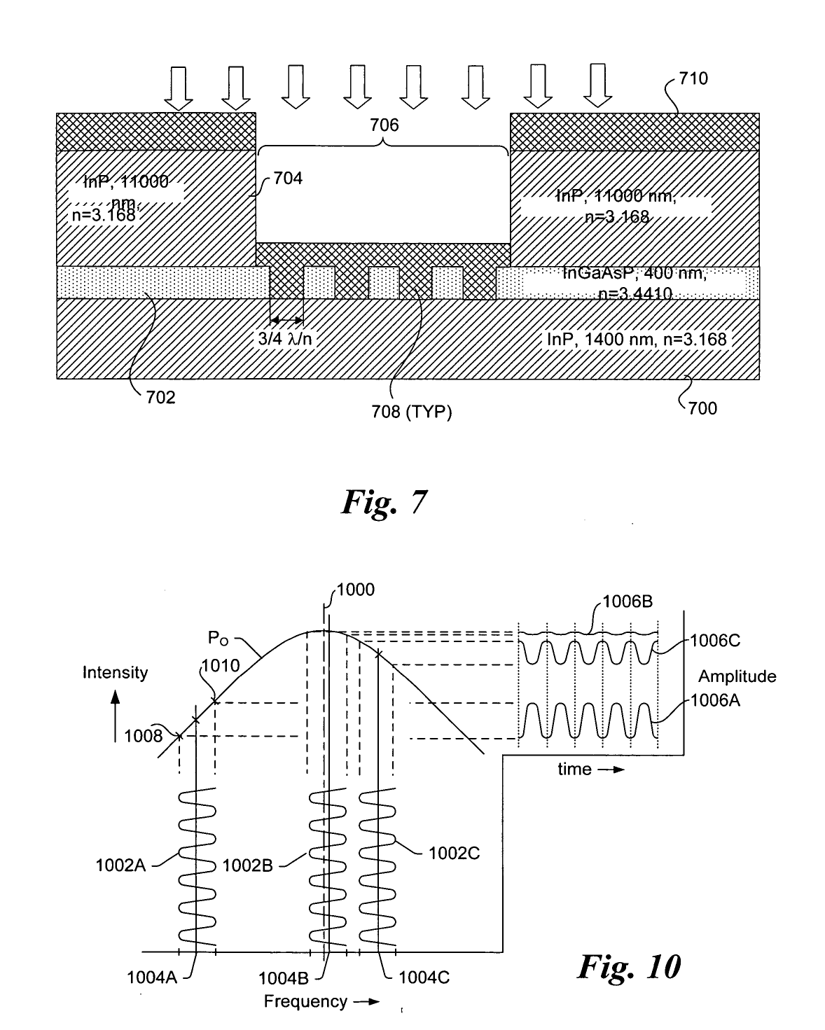

Another technique for forming the back-filled trench mirror structure is shown in FIG. 7. Under this technique, trenches are backfilled with amorphous material via sputtering, using an electron beam (e-beam) evaportion, or using chemical vapor deposition (CVD), all of which are well-known processes in the semiconductor manufacturing art. The process begins by building the waveguide structure, which includes an InP substrate 700, an InGaAsP waveguide core 702, and an InP waveguide upper cladding layer 704. In a manner similar to that employed for the embodiment of FIGS. 6a-b, this process involves growing an InP wafer with offset quantum wells. The quantum wells for a mirror section 706 are etched away, followed by re-growth of the upper cladding layer 704 and selective etching of the upper cladding to form the ridge.

Next, one or more trenches are formed in waveguide core 702. This begins by etching a small portion of the ridge just above the mirror structure (e.g., 2 μm×2 μm×3 μm). One or more ¾λ trenches 708 (four are illustrated) are then etched through waveguide core 702, which is 400 nm deep in the illustrated embodiment. A high-index amorphous material 710 is then formed over the structure, including portions extending on both sides of mirror section 706, via sputtering, e-beam evaporation, or CVD. This results in back-filling trenches 708 with the amorphous material.

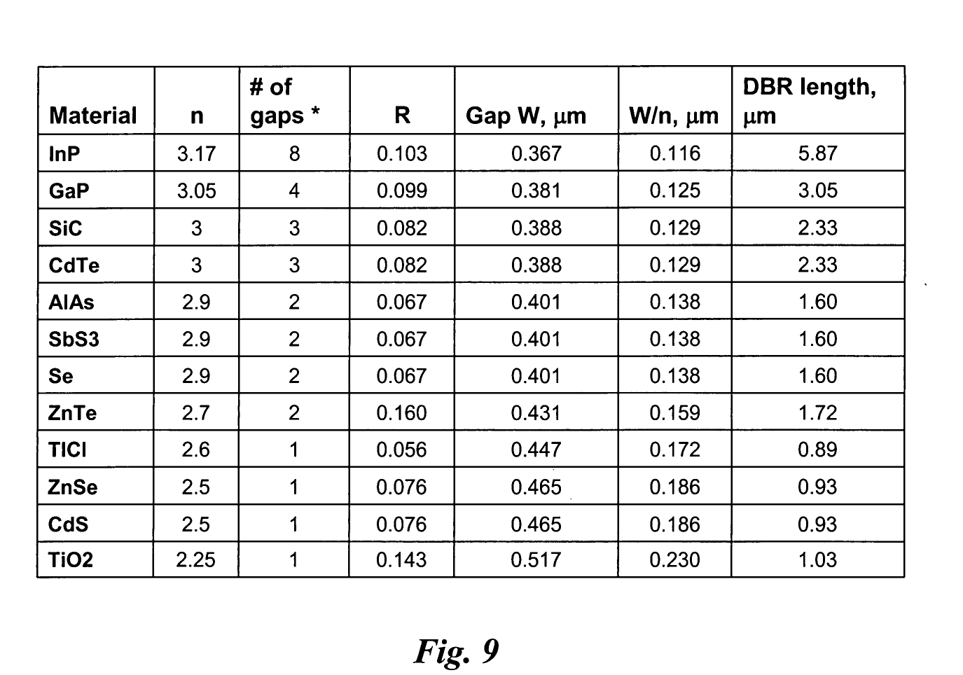

There are a variety of high-index amorphous materials that may be used for back-filling purposes. An exemplary set of materials is shown in the table of FIG. 9. For each material, the table includes an index of refraction n, the number of gaps (e.g., trenches) employed to obtain a total reflection of approximately 10% (calculated based on an effective modal refractive index of 3.3), R, the aggregate reflectivity of the one or more gaps, the gap width W, in μm, the ratio of W/n, in μm, and the effective length of the mirror section 706, in μm.

The back-filled trench mirror structure of the embodiments disclosed herein provides several advantages when compared with conventional approaches employed in DBR lasers. For instance, unlike traditional Bragg mirrors used in DBR lasers, these structures utilize deep etch throughout the waveguide core. As a result, reflectivity of each fringe gets larger, and the same effective reflectivity of the mirror can be achieved with fewer fringes. Also, the overlap of the guided mode within the etched region is less, thus the losses associated with etch roughness are reduced. Because of the small number of fringes (caused by respective trenches), reflectivity of the mirror is nearly constant across the C- (or L-) band, making these mirrors suitable for tunable laser applications for C- and L-band communication spectrums. Additionally, the two-step etching of ¾λ trenches provides low-aspect ratio structures, ensuring high-quality surfaces and suitability for backfill without shadowing.

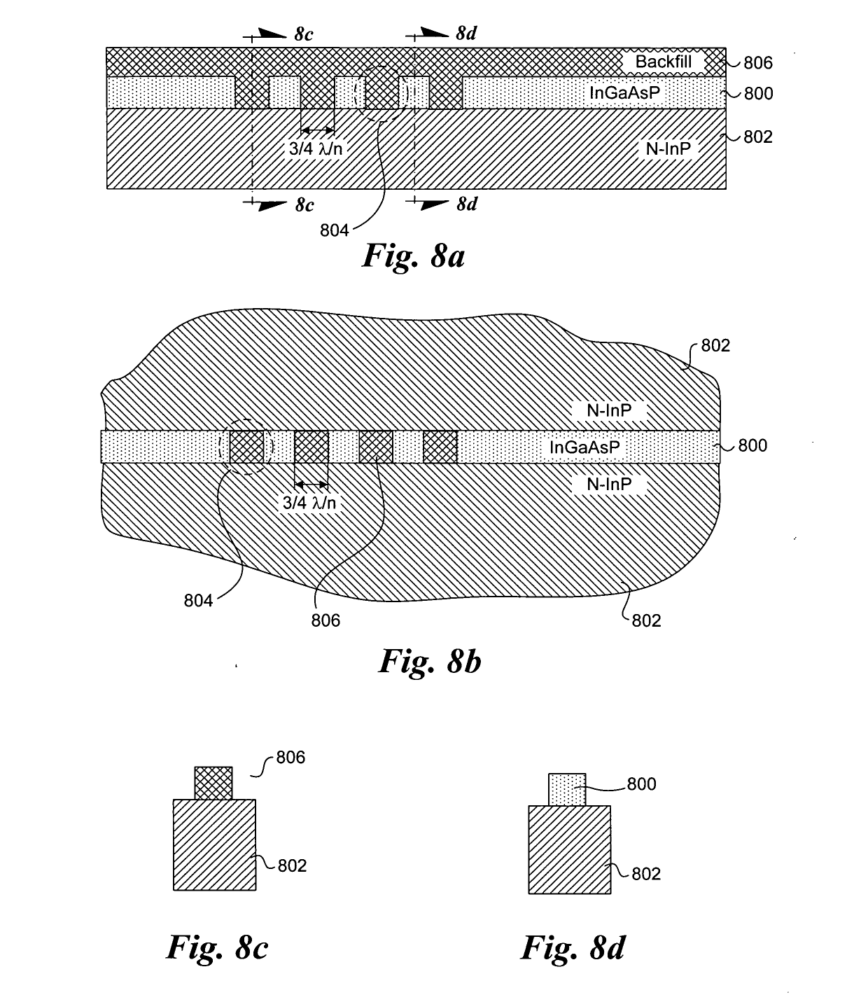

Another embodiment of the backfilled mirror structure incorporates removal of a narrow trench of waveguide core material and replacement with a backfilled material of different refractive index. Cross-sections corresponding to an exemplary embodiment using this technique are shown in FIGS. 8a-d. As shown by the cross-section of FIG. 8a, a waveguide core layer 800 comprising InGaAsP is formed over a lower cladding layer 802 of N—InP. The InGaAsP waveguide core 800 is patterned into a stripe and trenches 804 are then formed in the InGaAsP layer, followed by backfilling with backfill material 806. Finally, the backfilled material 806 is removed outside of the stripe. This structure can be formed utilizing commonly practiced techniques such as lift-off or etching to pattern the backfill material. The advantage of this structure is to guide, and contain the optical mode in the waveguide and minimize optical loss through the mirror due to diffraction.

Different techniques for monolithic integration of a gain section, modulator section, and optional phase control within a common gain chip have been developed. To minimize the absorption in the phase- and (unbiased) modulator sections the bandgap of these sections should be broadened by approximately 0.06-0.12 eV (blue shift of the absorption peak by 100-200 nm) compared to the gain section. This can be done by one of the following techniques. In each of the techniques, the integrated structure comprises a material suitable for forming applicable energy bandgaps. In one embodiment, the integrated structure is formed using an InGaAsP-based material.

A first technique uses an offset quantum-well (QW) structure (see, e.g., B. Mason, G. A. Fish, S. P. DenBaars, and L. A. Coldren, “Widely tunable sampled grating DBR laser with integrated electroabsorption modulator”, IEEE Photonics Technology Letters, vol. 11, No. 6, pp. 638-640, 1999). In this structure, the multiple quantum-well active layer is grown on top of a thick low bandgap (0.84-0.9 eV) quaternary waveguide. The two layers are separated by a thin (about 10 nm) stop etch layer to enable the QW's to be removed in the phase and modulator sections with selective etching. This low bandgap waveguide provides high index shift for the phase section of the laser at low current densities. The modulator section uses the same waveguide structure as the phase section with a reverse voltage applied to the electrodes.

A second technique, known as quantum well intermixing (QWI), relies on impurity or vacancy implantation into the QW region allowing its energy bandgap to be increased (see, e.g., S. Charbonneau, E. Kotels, P. Poole, J. He, G. Aers, J. Haysom, M. Buchanan, Y. Feng, A. Delage, F. Yang, M. Davies, R. Goldberg, P. Piva, and I. Mitchell, “Photonic integrated circuits fabricated using ion implantation”, IEEE J. Selected Topics in Quantum Electronics, vol. 4, No. 4, pp. 772-793, 1998 and S. McDougall, O. Kowalski, C. Hamilton, F. Camacho, B. Qiu, M. Ke, R. De La Rue, A. Bryce, and J. Marsh, “Monolithic integration via a universal damage enhanced quantum-well intermixing technique”, IEEE J. Selected Topics in Quantum Electronics, vol. 4, No. 4, pp. 636-646, 1998). Selective application of QWI to the phase control and modulator sections provides the required blue shift of the absorption peak of about 100-200 nm. This technique allows for better mode overlap with the quantum wells than the first technique.

A third technique employs asymmetric twin-waveguide technology (see, e.g., P. V. Studenkov, M. R. Gokhale, J. Wei, W. Lin, I. Glesk, P. R. Prucnal, and S. R. Forrest, “Monolithic integration of an all-optical Mach-Zehnder demultiplexer using an asymmetric twin-waveguide structure”, IEEE Photonics Technology Letters, vol. 13, No. 6, pp. 600-603, 2001) where two optical functions of amplification and modulation (phase control) are integrated in separate, vertically coupled waveguides, each independently optimized for the best performance.

In the modulator, the bulk waveguide material provides a wider spectral bandwidth than would be possible with a QW structure. Therefore, for widely tunable ECDL applications the first technique and the third technique with a bulk material in the modulator/phase section waveguide should provide better results than QWI technique.

The structure of the gain sections 400 in the embodiments described herein may be formed using well-known techniques for manufacturing gain medium structures. The parallel bars adjacent to the portion of the waveguides passing through the gain sections are included to indicate that this portion of the waveguide comprises the gain section for the integrated structure. In practice, a voltage differential is applied to layers above and below the waveguide core passing through the gain section to make this section of the waveguide function as a gain medium, as is well-known in the semiconductor laser art.

As shown in FIGS. 4b, 4d, 4f, and 4h, the gain section 400 is disposed between the phase control section 404 and mirror section 410, or 410A-C. This is not meant to be limiting, as the relative ordering of the sections can be switched. For example, FIG. 4i shows an integrated structure 302f having a phase control section 404 disposed between a gain section 400 and a mirror section 410B, which represents an alternative configuration for integrated structure 302f of FIG. 4f. Integrated structures 302b, 302d, and 302h may be modified in a similar manner such that their respective phase control section 404 is disposed between their gain sections and mirror sections.

In one embodiment, modulator sections 402 employ a Mach-Zehnder modulator. Mach-Zehnder modulators are well-known structures that operate under the principle of the Mach-Zehnder interferometer. An optical wave in an input portion of a waveguide is divided across the two arms (split waveguide portions) of the Mach-Zehnder modulator. A phase modulation is applied to one of the arms, or a differential phase modulation is applied across both arms. When the split portions of the optical wave are re-combined at the output portion of the waveguide, they can be either in- or out of phase depending on the optical path difference between two arms. This produces an amplitude modulation, which is used to modulate an optical communication signal with encoded data.

In addition, modulator 402 may comprise of one of various other types of components suitable for modulating an optical signal, including but not limited to an electroabsorption- or directional coupler-based modulator. Furthermore, a Mach-Zehnder-, electroabsorption- or directional coupler-based modulator may be co-packaged with the mirror, gain, and optional phase control sections to form an integrated structure, as depicted in the figures herein. Laser-to-modulator coupling can be achieved either directly by bringing two waveguides in close proximity to each other (about 1 micron—not shown) or by using coupling optics.

Another feature that may be integrated into a mirror structure, as well as along a separate portion of the waveguide is an angled mirror that has a mirror plane that is angled relative to a centerline of the waveguide core proximate to the angled mirror. For example, a backfilled mirror structure 414A with an angled mirror 416 is shown in an integrated structure 302F″ of FIG. 4j. The angled mirror is used to reflect a small portion (e.g., ˜1-2%) of the optical beam passing through the waveguide in a manner similar to the beam splitter discussed below. The split-off portion of the beam is then redirected toward a photo-electric device that measures optical power, such as a photodiode 420. The photo-electric device may be integrated into the integrated structure using well-known semiconductor manufacturing techniques (depicted at 422), or may be contained in separate packaging that is coupled to the integrated structure (depicted at 424).

Generally, the substrate material used for the integrated structure (e.g., the wafer material) will be optically transparent to the optical beam passing through the waveguide. As a result, in one embodiment the split-off beam is simply redirected to the photo-electric device through the bulk substrate material. However, this may lead to too much divergence of the beam, reducing the amount of energy that can be measured (and thus potentially reducing the effectiveness of the energy measurement). In this instance, it may be desired to form a small waveguide portion in the substrate, as depicted by a waveguide segment 426. This waveguide segment may be formed using well-known techniques.

Ideally, it is desired to precisely control the frequency of the output beam over a frequency range corresponding to the various channel frequencies the ECDL is designed for. Under one embodiment, a frequency control scheme is implemented by minimizing cavity losses when tuned to a selected channel. As described below in further detail, various techniques may be applied to “tune” ECDLs 300A-H to produce an optical output signal at a frequency corresponding to a desired communication channel. For example, this may be accomplished by adjusting one or more tuning elements, such as tuning filter elements 310, and producing a corresponding change in the cavity optical path length, thus changing the lasing mode frequency. The tuning filter elements attenuate the unwanted lasing modes such that the output beam comprises substantially coherent light having a narrow bandwidth.

Returning to the illustrated example of FIG. 2, note the transmission peak 208 of the cavity mode nearest the selected channel is misaligned with the transmission peaks for the grid generator and channel selector. As a result, the intensity of the laser output is attenuated due to the misalignment, which is reflected in the form of cavity losses. Various mechanisms may be employed to shift the cavity mode transmission peaks such that they are aligned with the grid generator and channel selector transmission peaks, thus controlling the laser frequency so it corresponds to the selected channel. Generally, under such schemes the optical path length of the laser cavity is adjusted so that it equals a multiple half-wavelength (λ/2) of the transmission wavelength selected by the grid etalon and channel selector (i.e., the wavelength at which grid etalon and channel selector transmission peaks are aligned). In one embodiment known as “wavelength locking,” an electronic servo loop is implemented that employs a modulated excitation signal that is used to modulate the overall cavity optical path length, thereby producing wavelength and intensity modulations in the laser output. A detection mechanism is employed to sense the intensity modulation (either via a measurement of the laser output intensity or sensing a junction voltage of the gain medium chip) and generate a corresponding feedback signal that is processed to produce a wavelength error signal. The wavelength error signal is then used to adjust the unmodulated (i.e., continuous or steady-state) overall cavity optical path length so as to align the transmission peak of the cavity mode with the transmission peaks of the grid generator and channel selector.

In accordance with another aspect of semi-integrated ECDLs 300 (B, D, F, H), wavelength locking is achieved via modulation of phase control section 404 (i.e., phase control modulation). Under this technique, a “dither” or modulation signal is supplied to cause a corresponding modulation in the optical path length of the portion of the waveguide passing through phase control section 404, and thus modulate the optical path length of the laser cavity. This produces a modulated phase-shift effect, resulting in a small frequency modulation (i.e., perturbation) of the lasing mode. The result of this frequency modulation produces a corresponding modulation of the intensity (power) of the output beam, also referred to as amplitude modulation. This amplitude modulation can be detected using various techniques. In one embodiment, the laser diode junction voltage (the voltage differential across gain section 400) is monitored while supplying a constant current to the gain section's laser diode, wherein a minimum measured diode junction voltage corresponds to a maximum output intensity. In another embodiment, a beam splitter is employed to split off a portion of the output beam such that the intensity of the split-off portion can be measured by a photo-electric device, such as a photodiode. The intensity measured by the photodiode is proportional to the intensity of the output beam. The measured amplitude modulation may then be used to generate an error signal that is fed back into a servo control loop to adjust the (substantially) continuous optical path length of the laser so as to produce maximal intensity.

One embodiment of the foregoing scheme is schematically illustrated in FIG. 10. The diagram shows a power output curve PO that is illustrative of a typical power output curve that results when the lasing mode is close to a desired channel, which is indicated by a channel frequency centerline 1000. The objective of a servo loop that employs the phase-shift modulation scheme is to adjust one or more optical elements in the laser cavity such that lasing frequency is shifted toward the desired channel frequency. This is achieved through use of a demodulated error signal that results from frequency modulation of the lasing mode. Under the technique, a modulation (dither) signal is used to modulate the optical path length of the effective laser cavity by modulating the optical path length of phase control section 404. In the illustrated embodiment, a modulated signal comprising a wavelength locking excitation signal 332 is generated by a dither driver 334 and supplied to phase control section 404. This modulation causes a frequency excursion that is relatively small compared to the channel spacing for the laser. For example, in one embodiment the modulation may have an excursion of 4 MHz, while the channel spacing is 50 GHz.

Modulated signals 1002A, 1002B, and 1002C respectively correspond to (average) laser frequencies 1004A, 1004B, and 1004C. Laser frequency 1004A is less than the desired channel frequency, laser frequency 1004C is higher than the desired channel frequency, while 1004B is near the desired channel frequency. Each modulated signal produces a respective modulation in the intensity of the output beam; these intensity modulations are respectively shown as modulated amplitude waveforms 1006A, 1006B, and 1006C. Generally, the intensity modulations can be measured in the manners discussed above for determining the intensity of the output beam.

As depicted in FIG. 10, the peak-to-valley amplitude of waveforms 1006A, 1006B, and 1006C is directly tied to the points in which the modulation limits for their corresponding frequency modulated signals 1002A, 1002B, and 1002C intersect with power output curve PO, such as depicted by intersection points 1008 and 1010 for modulated signal 1002A. Thus, as the laser frequency gets closer to the desired channel frequency, the peak to valley amplitude of the measured intensity of the output beam decreases. At the point where the laser frequency and the channel frequency coincide, this value becomes minimized.

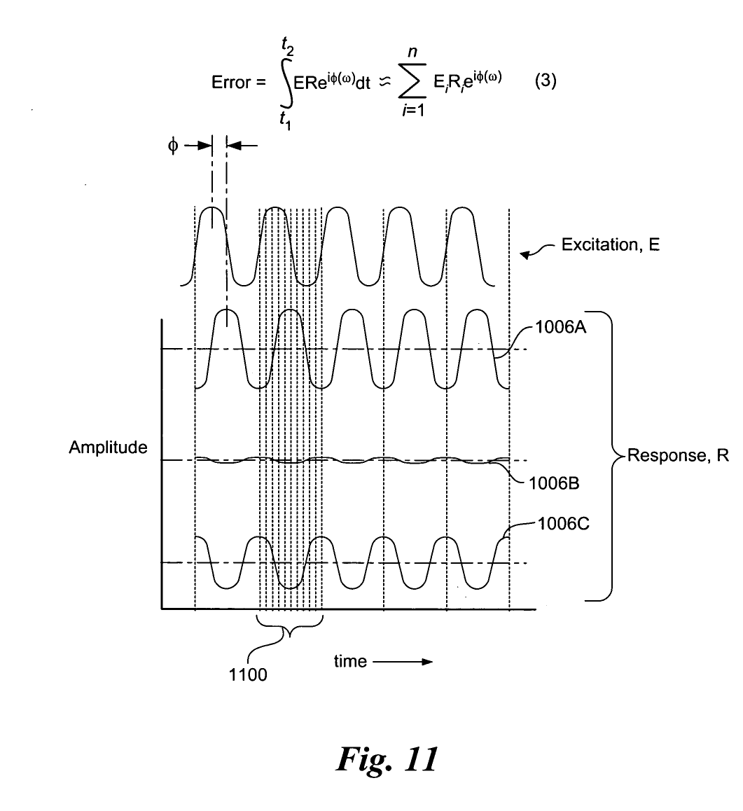

Furthermore, as shown in FIG. 11, the error may be derived from the equation:

$$Error = {\int }_{{t}_{1}}^{{t}_{2}} ER {ⅇ}^{i ϕ ( ω )} ⅆ t \approx {\sum }_{i = 1}^{n} {E}_{i} {R}_{i} {ⅇ}^{i ϕ ( ω )} \qquad ( 3 )$$

wherein the non-italicized i is the imaginary number, Φ represents the phase difference between the excitation input (i.e., modulated signals 1002A, 1002B, and 1002C) and the response output comprising the amplitude modulated output waveforms 1006A, 1006B, and 1006C, and ω is the frequency of modulation. The integral solution can be accurately approximated by a discreet time sampling scheme typical of digital servo loops, as depicted by time sample marks 1100.

In addition to providing an error amplitude, the foregoing scheme also provides an error direction. For example, when the laser frequency is in error on one side of the desired channel frequency (lower in the illustrated example), the excitation and response waveforms will be substantially in phase. This will produce a positive aggregated error value. In contrast, when the laser frequency is on the other side of the desired channel frequency (higher in the example), the excitation and response waveforms are substantially out of phase. As a result, the aggregated error value will be negative.

Generally, the wavelength locking frequency of modulation ω should be selected to be several orders of magnitude below the laser frequency. For example, modulation frequencies within the range of 500 Hz-100 kHz may be used in one embodiment with a laser frequency of 185-199 THz.

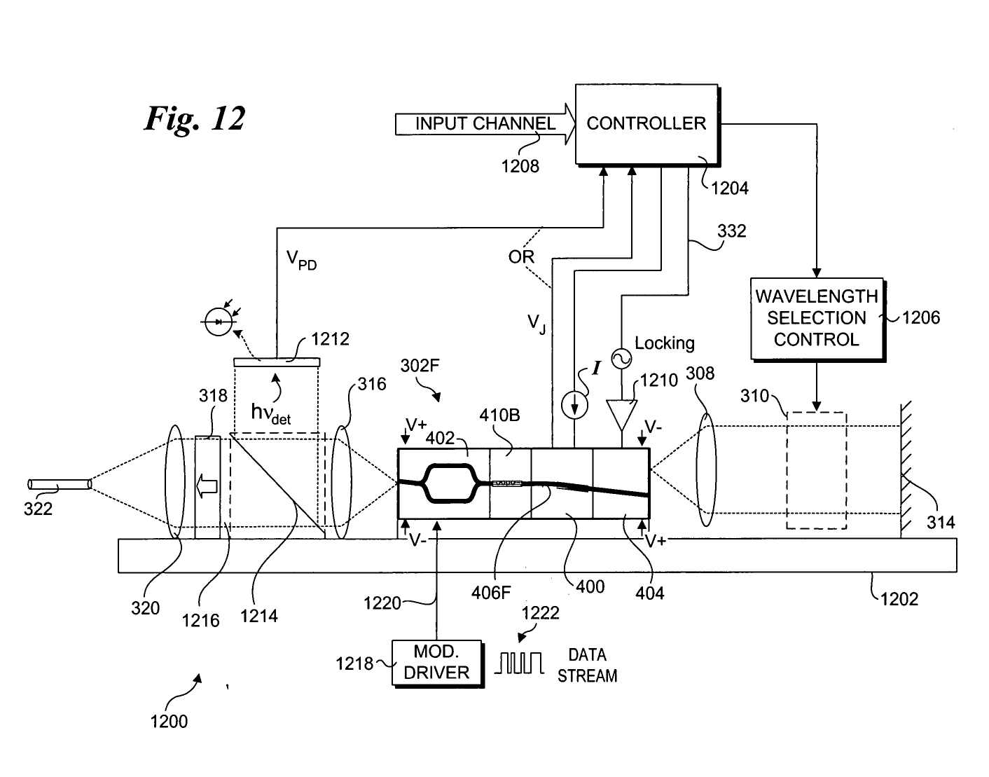

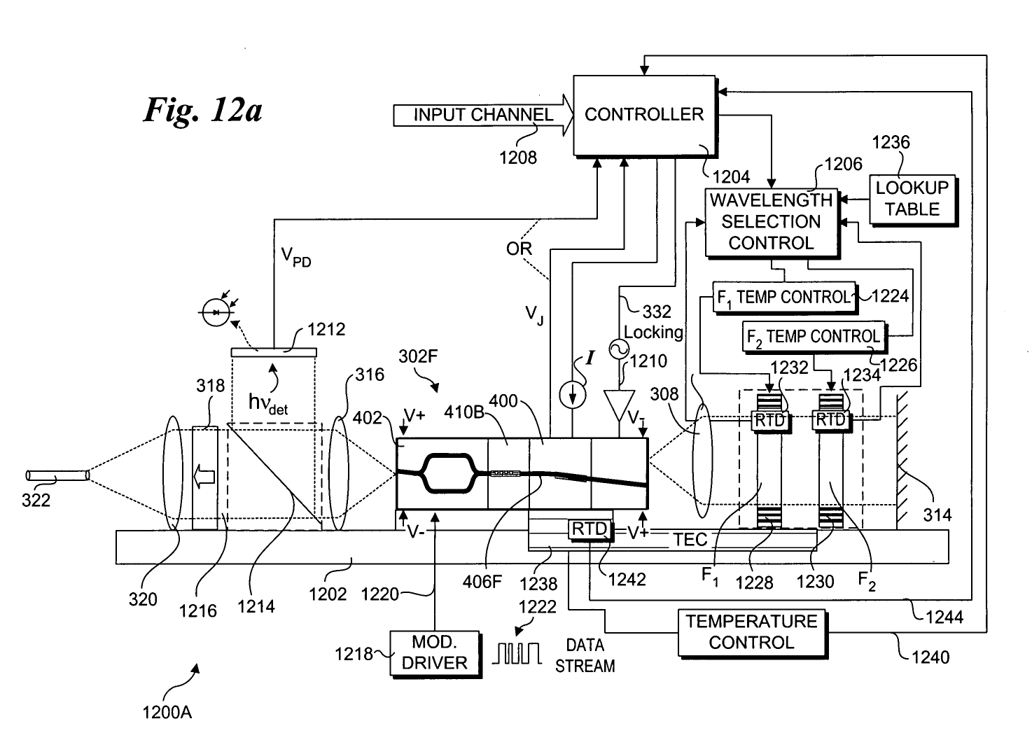

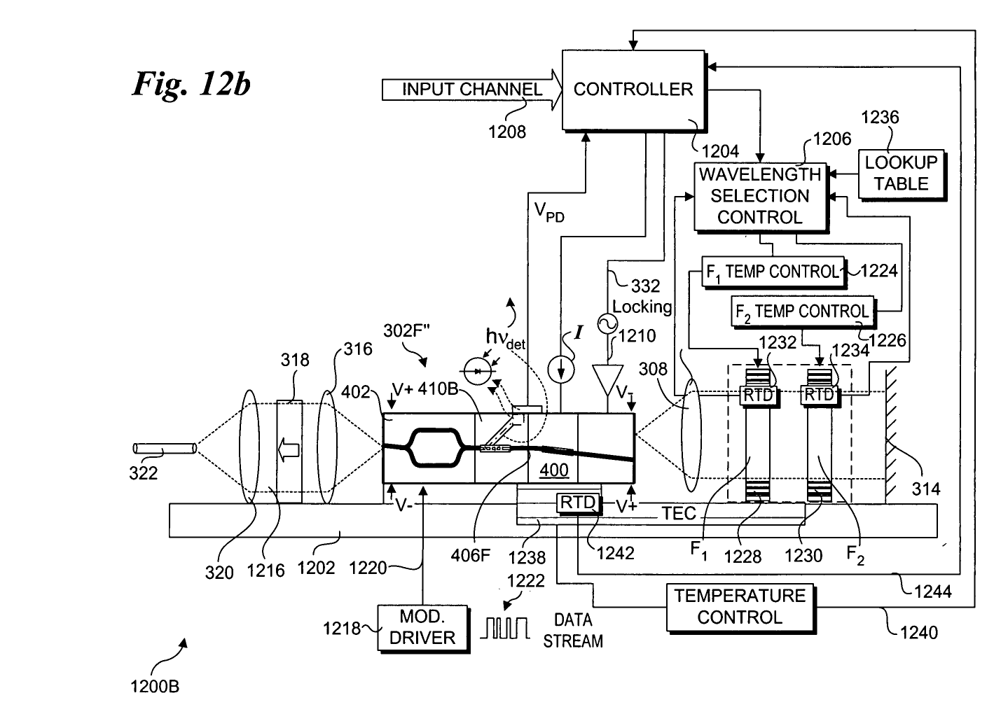

The teachings and principles of the embodiments disclosed herein may be implemented in semi-integrated ECDL lasers having a general configuration similar to those shown in each of FIGS. 3A-H. For example, with reference to FIG. 12, an ECDL 1200 is shown including various elements common to ECDL 300F having like reference numbers, such as an integrated structure 302F, collimated lens 308, etc. The various optical components of the ECDL 1200 are mounted or otherwise coupled to a base 1202. For the purpose of illustration, the integrated structure 302F is not shown in its proper orientation in FIG. 12; in practice, the configuration would resemble that shown in FIG. 3f.

Semi-integrated ECDL 1200 includes a controller 1204 that is used to effect tuning in response to an input channel signal 1208. In general, input to the phase control section 404 will be used for very fine tuning adjustments, while coarser tuning adjustments will be made by means of tuning filter element(s) 310. Generally, tuning filter elements may comprise one or more etalons, gratings, prisms or other element or elements that are capable of providing feedback to gain section 400 at a selected wavelength or sets of wavelengths. The tuning filter element(s) 310 are controlled by a wavelength selection control block 1206, which in turn is coupled to or included as part of controller 1204. In response to an input channel command 1208, the controller and/or wavelength selection control block adjust the tuning filter element(s) and phase control section 404 so as to produce a lasing mode corresponding to the desired channel frequency.

In some embodiments, the semi-integrated ECDLs described herein may employ a wavelength-locking (also referred to as channel-locking) scheme so as to maintain the laser output at a selected channel frequency (and thus at a corresponding predetermined wavelength). Typically, this may be provided via the phase modulation scheme described above, wherein the optical path length of the laser cavity is modulated at a relatively low frequency (e.g., 500 Hz-20 KHz) at a small frequency excursion. In one embodiment, phase control section 404 is employed for this purpose. In response to a modulated wavelength locking excitation signal 332 generated by controller 1204 and amplified by an amplifier 1210, the optical path length of phase control section 404 (along waveguide 406F) is caused to modulate, thereby inducing a wavelength modulation in the laser's output. Generally, the optical path length modulator may comprise an element that changes its optical path length in response to an electrical input. In one embodiment, the modulation is caused by energizing the active region in waveguide 406F in the phase control section 404. As a result, by providing a modulated current signal across the quantum well, the optical path length of the laser cavity can be caused to modulate.

As is well-known, when the laser's output has a frequency that is centered on a channel frequency (in accordance with appropriately configured filter elements), the laser intensity is maximized relative to non-centered outputs. As a result, the wavelength modulation produces an intensity modulation having an amplitude indicative of how off-center the lasing mode is, as discussed above with reference to FIGS. 10 and 11. A corresponding feedback signal may then be generated that is received by controller 1204 and processed to adjust the overall cavity length via phase control section 404.

For example, in the illustrated embodiment of FIG. 12, a photodetector 1212 is used to detect the intensity of the laser output. A beam splitter 1214 is disposed in the optical path of output beam 1216, causing a portion of the output beam light to be redirected toward photodetector 1212. In one embodiment, photodetector 1212 comprises a photo diode, which generates a current in response to the light intensity it receives (hν_{det}). A corresponding voltage V_{PD} is then fed back to controller 1204.

In one embodiment, controller 1204 includes a digital servo loop (e.g., phase lock loop) that is configured to adjust phase control section 404 such that the amplitude modulation of the light intensity detected at photodectector 1212 is minimized, in accordance with a typical intensity vs. frequency curve for a given channel and corresponding filter characteristics. In another embodiment, the junction voltage across gain diode chip (V_{J}) is employed as the intensity feedback signal, rather than V_{PD}. An error signal is then derived based on the amplitude modulation and phase of V_{PD} or V_{J} in combination with wavelength locking excitation signal 332. In response to the error signal, an appropriate adjustment to the DC component of the signal 332 is generated. Adjustment of phase section 404 causes a corresponding change in the overall (continuous) cavity length, and thus the lasing frequency. This in turn results in (ideally) a decrease in the difference between the lasing frequency and the desired channel frequency, thus completing the control loop.

Semi-integrated ECDL 1200 also provides for data modulation via the integrated modulator section 402. For example, light in waveguide 406F passing out of the laser cavity through mirror structure 414 comprises a non-modulated output signal (initially). By applying a modulated voltage across the portion of waveguide 406F passing through modulator section 402 (depicted as a Mach-Zehnder modulator), the output signal can be modulated with data. In one embodiment, a modulator driver 1218 is used to generate a modulator drive signal 1220 to form a modulated output signal in response to an input data stream 1222. In general, modulator driver 1218 may comprise a separate component, or may be integrated into and/or controlled by controller 1204.

In general, various tuning filter elements and corresponding tuning adjustment techniques may be employed for channel selection purposes. For example, in a semi-integrated ECDL 1200A shown in FIG. 12a, tuning filter elements 310 comprise first and second tunable filters F_{1 and F}₂. In one embodiment, filters F_{1 and F}₂ comprise respective etalons, either made of a solid material or being gas filled. In one embodiment, filter tuning is effectuated by changing the optical path length of each etalon. This in turn may be induced by changing the temperature of the etalons, according to one embodiment. Alterative, the etalons may be made of an electro-optic material that changes its index of refraction in response to an electric input (e.g., Lithium Niobate).

Semi-integrated ECDL 1200A now also shows further details of an exemplary channel selection subsystem. It is noted that although the wavelength selection control block is shown external to controller 1204, the control aspects of this block may be provided by the controller alone. Wavelength selection control block 1206 provides electrical outputs 1224 and 1226 for controlling the temperatures of filters F₁ and F₂, respectively. In one embodiment, a temperature control element is disposed around the perimeter of a circular etalon, as depicted by heaters 1228 and 1230. Respective RTDs 1232 and 1234 are employed to provide a temperature feedback signal back to wavelength selection control block 1206.

Generally, etalons are employed in laser cavities to provide filtering functions. As discussed above, they essentially function as Fabry-Perot resonators, and provide a filtering function defining a set of transmission peaks in the laser output. The FSR spacing of the transmission peaks is dependent on the distance between the two faces of the etalon. As the temperatures of the etalons change, the etalon material is caused to expand or contract, thus causing the distance between the faces to change. In addition, temperature change causes change of the refractive index of the etalons. This effectively changes the optical path length of the etalons, which may be employed to shift the transmission peaks.

The effect of the filters is cumulative. As a result, all lasing modes except for a selected channel lasing mode can be substantially attenuated by lining up a single transmission peak of each filter. In one embodiment, the configurations of the two etalons are selected such that the respective free spectral ranges of the etalons are slightly different. This enables transmission peaks to be aligned under a Vernier tuning technique similar to that employed by a Vernier scale. In one embodiment, one of the filters is employed as a grid generator, and is configured to have a free spectral range corresponding to a communications channel grid, such as the ITU wavelength grid. This wavelength grid remains substantially fixed by maintaining the temperature of the corresponding grid generator etalon at a predetermined temperature. At the same time, the temperature of the other etalon, known as the channel selector, is adjusted so as to shift its transmission peaks relative to those of the grid generator. By shifting the transmission peaks of the channel selector in this manner, transmission peaks corresponding to channel frequencies may be aligned, thereby producing a cavity lasing mode corresponding to the selected channel frequency. In another embodiment, the transmission peaks of both the filters are concurrently shifted to select a channel.

Generally, either of these schemes may be implemented by using a channel-etalon filter temperature lookup table in which etalon temperatures for corresponding channels are stored, as depicted by lookup table 1236. Typically, the etalon temperature/channel values in the lookup table may be obtained through a calibration procedure, through statistical data, or calculated based on tuning functions fit to the tuning data. In response to input channel command 1208, the corresponding etalon temperatures are retrieved from lookup table 1236 and employed as target temperatures for the etalons using appropriate temperature control loops, which are well-known in the art.

A semi-integrated ECDL 1200B that is similar to ECDL 1200A is shown in FIG. 12b. Under this configuration, an integrated structure 302F″ is used in place of integrated structure 302F. As discussed above, integrated structure 302F″ includes an angled mirror that is used to split-off a portion of the optical beam passing through the waveguide. This is a similar function to that performed by beam-splitter 1214 in ECDL 1200A. As a result, a separate beam-splitter (e.g. beam-splitter 1214) is not required, and the optical power of the laser output can be directly measured by a photo-electric device that is either built-into integrated structure 302F″, or attached to the integrated structure in the manner discussed above.

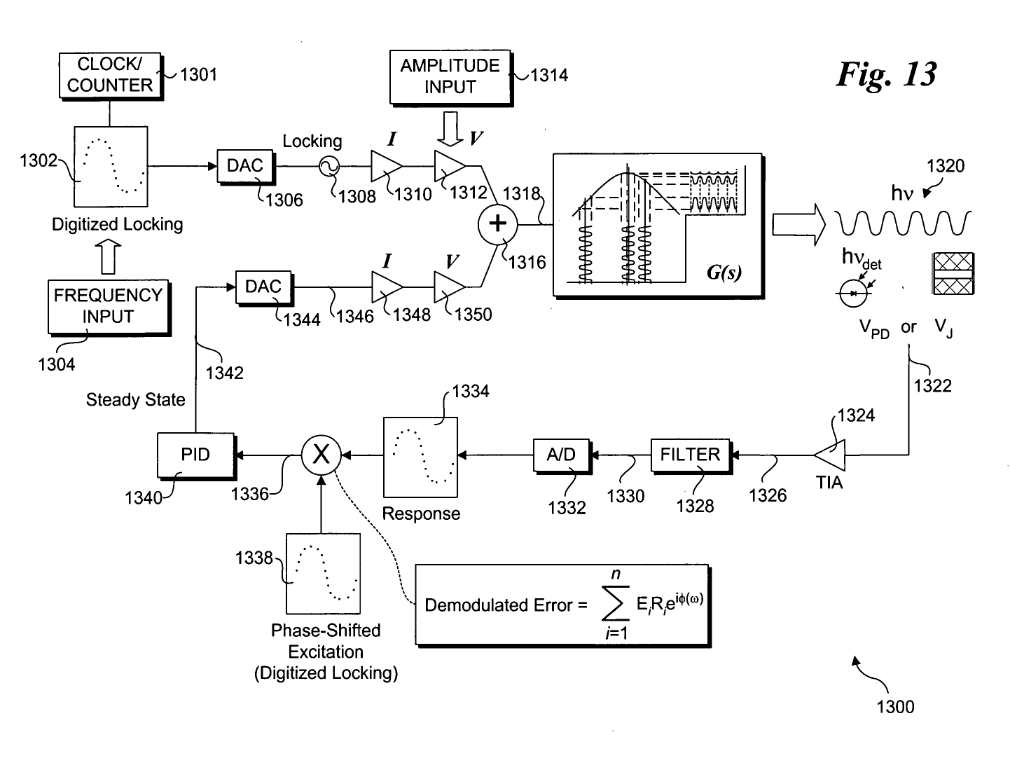

A servo control block diagram 1300 corresponding to control operations performed by controller 1204 and related components in accordance with one embodiment of the invention is shown in FIG. 13. The servo loop employs a digital sampling scheme common to many digital control systems. In one embodiment, the sampling frequency is 100 Hz. A signal indicating the start of each sampling period is provided by a clock/counter 1301. During each sampling period, respective values from a digitized excitation signal waveform 1302 retrieved. Generally, digitized excitation signal waveform 1302 may be stored in a lookup table containing a drive signal value column and a cycle count column. Optionally, a current signal value may be generated in real-time based on an appropriate waveform function, such as Sin(θ), where θ is determined as a function of the clock count for the current cycle.

In one embodiment, the frequency of the excitation signal may be selected via a corresponding input control, such as depicted by a frequency input block 1304. Generally, the frequency input may be provided by means of an analog or digital control (e.g., an analog or digital potentiometer), or by means of a computer-based input. For example, a software program running on a host computer may provide a user-interface to enable a user to select a frequency of the excitation signal. Corresponding information could then be communicated to controller 1204. In one embodiment, respective lookup tables are provided for various frequencies or ranges of frequency. In the real-time sinusoid calculation, the update frequency or granularity of the calculation may be adjusted based on the selected frequency.

In one embodiment, appropriate waveform values are retrieved from a lookup table and provided as an input to a digital-to-analog converter (DAC) 1306. When a digitized waveform is fed into a DAC at a fixed rate (i.e., sampling frequency), the DAC will output a smoothed analog waveform corresponding to the input digital waveform. This analog waveforms is depicted as modulation signal 1308.

Next, the modulation signal is fed into an amplifier to amplify both the drive current and voltage amplitude of the signal, thereby producing an appropriate excitation signal that is used to drive the cavity optical path length modulator. This amplification is depicted by respective current and voltage amplifiers 1310 and 1312. In addition to frequency control, means may be provided for selecting and/or adjusting the line width of the laser output, which is dependent on the frequency excursion caused by the cavity optical path length modulation amplitude. In one embodiment, a control input similar to that described above for frequency input 1304 is employed, as depicted by an amplitude input block 1314.

The amplified modulation signal is next combined with a steady state tuning feedback signal at an adder block 1316 to form a combined drive signal 1318. As described below in further detail, the steady state tuning signal is used to provide a steady state current to the phase control section 404, while the amplified modulation signal comprises a current that is modulated on top of the steady state signal.

The combined drive signal is supplied to the phase control section 404 of an integrated structure to cause a modulation in the laser cavity optical path length (more specifically, the portion of the waveguide passing through the phase control section), resulting in a modulation in the wavelength and intensity of the output of the laser. This corresponds to a transfer function G(s) of the laser, with the resulting wavelength and intensity modulations shown at 1320.

In response to a detected intensity modulation in the laser output, a corresponding electrical feedback signal 1322 is generated. As described above, this feedback signal may comprise a signal derived from direct measurement of the intensity modulation using a photo-electric sensor or the like (as depicted by V_{PD}), or may be obtained by measuring the laser diode junction voltage V_{J}, which is indicative of the intensity modulation. The electrical feedback signal is then amplified by a trans-impedance amplifier (TIA) 1324, producing an amplified electrical feedback signal 1326.

At this point, the amplified feedback signal may be passed through an optional filter 1328. In one embodiment, filter 1328 comprises a bandpass filter. In general, the band-pass filter should be configured to enable signal components having frequencies corresponding to the modulation frequency range to pass through, while substantially attenuating other signal components above or below these frequencies. In another embodiment, a low-pass filter is employed instead of a band-pass filter. In this instance, the cut-off frequency of the low-pass filter should be selected based on the maximum anticipated modulation frequency to be employed. In yet another embodiment, the band-pass or low-pass filter is tunable, enabling the filter characteristics to be tuned in accordance with the modulation frequency currently employed.

Thus, after passing through filter 1328 (if employed), a filtered feedback signal 1330 is produced. This feedback signal is then fed into an analog-to-digital (A/D) converter 1332, which converts the signal into a digital pulse train, illustrated by a digitized response waveform 1334. This waveform is illustrative of the modulation intensity produced in response to the excitation signal, as discussed above with reference to FIG. 10.

Next, a demodulated error signal 1336 is produced. As discussed above, the demodulated error signal can be derived by the dot product of the response waveform times the excitation waveform in accordance with the summation formula of equation 3. This will generally be a function of the phase shift angle Φ between the excitation signal input and the resulting response signal output. It is advantageous to eliminate this phase shift angle, as it may lead to inconsistent error signals. In one embodiment, this is performed by digitally shifting the excitation by an amount substantially equal to the phase shift, as depicted by phase-shifted excitation signal 1338. Generally, the amount of phase shift, which represents a time delay, can be numerically calculated or empirically derived (most common). In general, the primary components of the phase shift are due to time delays caused by the various amplifiers, filters, and optical elements employed to induce the intensity modulation and process the corresponding feedback signal.

The demodulated error signal is then provided as an input to a PID (proportional, integral and derivative) control block 1340, which is well known in the control system art. The PID block outputs a digital steady state drive signal 1342, which is converted into an analog signal 1346 by DAC 1344. This analog signal is then fed into an amplifier to amplify both the drive current and voltage amplitude of the signal, thereby producing an appropriate steady state drive signal that is used to provide the steady state drive current to the phase control section. This amplification is depicted by respective current and voltage amplifiers 1348 and 1350.

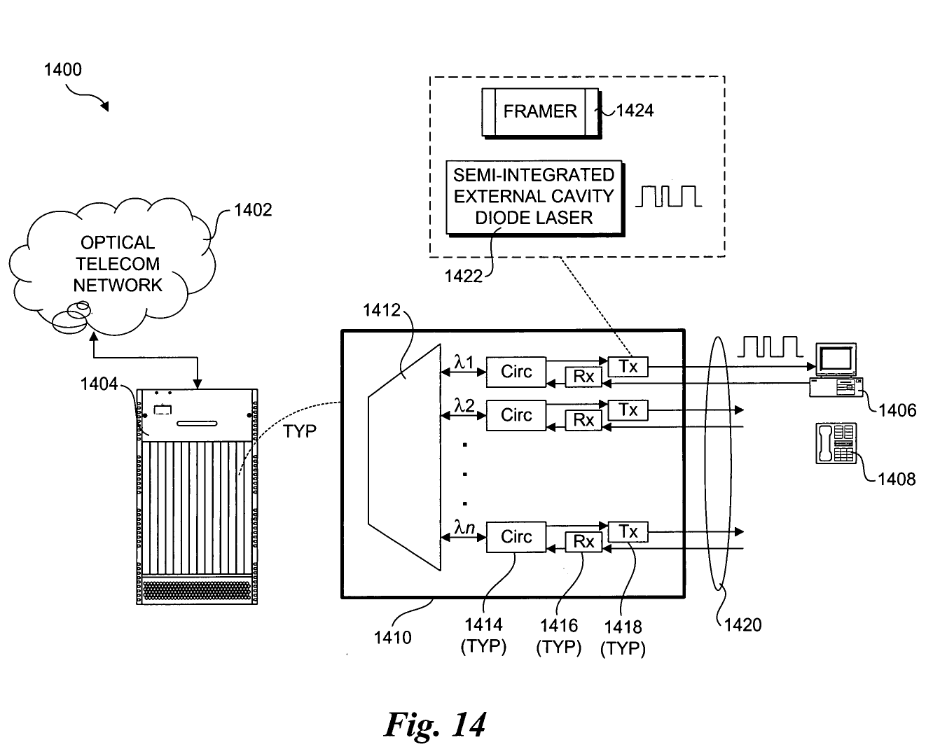

FIG. 14 shows a communication system 1400 in accordance with an embodiment of the invention in which an optical network is coupled to a plurality of data and voice subscribers lines by an optical mux/demux utilizing tunable semi-integrated ECDL's that may be tuned to the center frequency of any of the WDM channels on the optical network. The communication system includes an optical network 1402, a network switch 1404, a data terminal 1406, and a voice terminal 1408. The modulated data may be carried on a number of channels in multiple access protocols including but not limited to: wavelength division multiplexing (WDM), dense wavelength division multiplexing (DWDM), frequency division multiple access (FDMA), etc. Currently, this expansion of bandwidth is primarily being accomplished by WDM, in which separate subscriber/data session may be handled concurrently on a single optical fiber by means of modulation of each of those subscriber data streams on different portions of the light spectrum. The precise center frequencies of each channel are specified by standard setting organizations such as the International Telecommunications Union (ITU). The center frequencies are set forth as part of a wavelength grid that defines the center frequencies and spacing between channels. Typically, the channel frequencies are evenly spaced so that the separation between any two channels is an integer multiple of a selected fundamental spacing.

Network switch 1404 provides network-switching operations, as is well-known in the art. This is facilitated by optical transceivers that are mounted on fiber line cards 1410. Each fiber line card includes a multi-state multiplexer/demultiplexer (mux/demux) 1412, a circulator bank including circulators 1414, a receiver bank including receivers 1416, and a transmitter bank including transmitters 1418. The mux/demux is a passive optical device that divides wavelengths (or channels) from a multi-channel optical signal, or combines various wavelengths (or channels) on respective optical paths into one multi-channel optical signal depending on the propagation direction of the light.

In the receive mode, after de-multiplexing, each individual channel is passed via a corresponding circulator 1414 within the circulator bank to a corresponding receiver 1416 in the receiver bank. Each receiver 1416 includes a narrow bandpass photodetector, framer, and decoders (not shown). Switches (not shown) couple the receiver over a corresponding one of subscriber lines 1420 to a data or voice terminal 1406 or 1408, respectively.

In the transmit mode, each line card transmitter bank includes a bank of lasers 1422, including n (e.g., 128) semi-integrated ECDLs radiating light at one of the selected center frequencies of each channel of the telecommunications wavelength grid. The wavelength range of current ITU-defined grids is split between three bands: S-band (1492-1529 nm), C-band (1530-1570 nm), and L-band (1570-1612 nm). Each subscriber datastream is optically modulated onto the output beam of a corresponding ECL having a construction and operation in accordance with the embodiments of the invention discussed above. A framer 1424 permits framing, pointer generation and scrambling for transmission of data from the bank of semi-integrated ECDLs and associated drivers. The modulated information from each of the lasers is passed via a corresponding circulator into mux/demux 1412, which couples the output to a single optical fiber for transmission. The operation of the fiber line card in the embodiment shown is duplex, meaning that bi-directional communications are possible.

Each of the embodiments described herein provide advantages over the conventional ECDL configurations, as well as DFB and DBR laser configurations. For example, conventional ECDL's may employ mechanical or thermal cavity length actuators, which have a substantially slower response time (1-1000 milliseconds) than equivalent response time provided by an integrated phase control section (˜1 nanosecond). Thus, replacing the conventional cavity length control function with an integrated phase control section makes channel locking much faster and more robust. Integration of the data modulator section into the same chip offers a significant cost advantage over traditional Lithium Niobate Mach-Zehnder modulators. In addition, integrated modulators take much less space than Lithium Niobate Mach-Zehnder modulators.

As discussed above, the semi-integrated ECDL designs have the manufacturing benefit of integrated structures, while still providing decoupled tuning mechanisms. This leads to enhanced performance over tunable DFB and DBR lasers.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. An apparatus, comprising:
an integrated structure having front and rear facets optically coupled via a waveguide passing therethrough, the integrated structure further including:
a gain section to emit a plurality of photons in response to a first electrical input;
a modulator section, optically coupled to the gain section via a portion of the waveguide, to modulate an optical output passing through the waveguide in response to a second electrical input, and having a facet defining the front facet of the integrated structure; and
a partially-reflective mirror formed within a mirror section comprising the portion of the waveguide disposed between the gain section and the modulator section.

2. The apparatus of claim 1, further comprising a phase control section formed adjacent to the gain section, wherein one of the gain section or phase control section includes a facet defining the rear facet of the integrated structure.

3. The apparatus of claim 1, wherein the partially-reflective mirror is effectuated by a high-aspect ratio cut passing through a waveguide core in the mirror section and disposed substantially perpendicular to a longitudinal axis passing through the waveguide core.

4. The apparatus of claim 3, wherein the high-aspect ratio cut is formed using a focused ion beam.

5. The apparatus of claim 1, wherein the partially-reflective mirror is effectuated by one or more low-aspect ratio trenches extending through a waveguide core, said one or more low-aspect ratio trenches being backfilled with a material having an index of refraction differing from an index of refraction of the waveguide core.

6. The apparatus of claim 5, wherein the index of refraction n of the backfill material is between 2 and 3.

7. The apparatus of claim 5, wherein the backfill material comprises a re-grown crystalline structure.

8. The apparatus of claim 5, wherein the backfill material comprises an amorphous material.

9. The apparatus of claim 5, wherein one of the trenches is etched at an angle relative to a longitudinal centerline of the waveguide core proximate to the trench, the trench when backfilled functioning as an angled mirror that is used to split-off a portion of an optical beam passing through the waveguide during operation of the apparatus.

10. The apparatus of claim 9, further comprising a photo-electric device built-into the integrated structure and positioned to receive the split-off portion of the optical beam, the photo-electric device to produce an output signal indicative of an energy level of the split-off portion of the optical beam.

11. The apparatus of claim 1, wherein the waveguide is bent such that it is substantially perpendicular proximate to the mirror section and angled relative to the front and rear facets of the integrated structure.

12. The apparatus of claim 1, wherein the waveguide is tilted such that it angled relative to the front and rear facets of the integrated structure and a crystalline structure for the integrated structure.

13. The apparatus of claim 1, wherein a bandgap of a portion of the waveguide passing through the modulator section is broadened approximately 0.06-0.12 eV (electron-volts) relative to a bandgap of the portion of the waveguide passing through the gain section.

14. The apparatus of claim 1, wherein portions of the waveguide passing through the gain and modulator sections comprise one of an offset quantum-well structure or a quantum-well intermixed structure.

15. The apparatus of claim 1, wherein the portion of the waveguide passing through the modulator section is configured as a Mach-Zehnder modulator.

16. The apparatus of claim 1, wherein the waveguide core of the integrated structure is formed from an InGaAsP (Indium-Gallium-Arsenic-Phosphorus)-based semiconductor material.

17. A tunable laser, comprising:
a base;
an integrated structure operatively coupled to the base, having a substantially non-reflective front facet and rear facet optically coupled via a waveguide passing therethrough, the integrated structure further including:
a gain section to emit a plurality of photons in response to a first electrical input, having a facet defining the rear facet of the integrated structure;
a modulator section, optically coupled to the gain section via a portion of the waveguide, to modulate an optical output generated by the tunable laser passing through a portion of the waveguide disposed in the modulator section in response to a second electrical input, and having a facet defining the front facet of the integrated structure; and
a partially-reflective in-waveguide mirror formed within a mirror section comprising the portion of the waveguide disposed between the gain section and the modulator section;
a reflective element, operatively coupled to the base and disposed opposite the substantially non-reflective rear facet to form an external cavity; and
a tunable filter including at least one optical element operatively coupled to the base and disposed in the external cavity.

18. The tunable laser of claim 17, wherein the partially-reflective in-waveguide mirror is effectuated by a high-aspect ratio cut passing through a waveguide core in the mirror section and disposed substantially perpendicular to a longitudinal axis passing through the waveguide core.

19. The tunable laser of claim 18, wherein the high-aspect ratio cut is formed using a focused ion beam.

20. The tunable laser of claim 17, wherein the partially-reflective in-waveguide mirror is effectuated by a one or more low-aspect ratio trenches passing through a waveguide core in the mirror section, said one or more low-aspect ratio trenches being backfilled with a backfill material having an index of refraction differing from an index of refraction of the waveguide core.

21. The tunable laser of claim 20, wherein the backfill material comprises a re-grown crystalline structure.

22. The tunable laser of claim 20, wherein the backfill material comprises an amorphous material.

23. The tunable laser of claim 17, wherein the modulator section comprises one of an electroabsorption-, Mach-Zehnder-, or directional coupler-based modulator.

24. The tunable laser of claim 17, further comprising a phase control element disposed in the external cavity.

25. A tunable external cavity diode laser (ECDL), comprising:
a base;
an integrated structure operatively coupled to the base, having a substantially non-reflective front facet and rear facet optically coupled via a waveguide passing therethrough, the integrated structure further including:
a gain section to emit a plurality of photons in response to a first electrical input,
a phase control section disposed adjacent to the gain section, to modulate an optical path length of a portion of the waveguide passing through the phase control section in response to a second electrical input;
a modulator section, optically coupled to the gain section and phase control section via a portion of the waveguide, to modulate an optical output generated by the tunable laser passing through a portion of the waveguide disposed in the modulator section in response to a third electrical input, and having a facet defining the front facet of the integrated structure; and
a partially-reflective in-waveguide mirror formed within a mirror section comprising the portion of the waveguide disposed between the modulator section and one of the gain section and phase control section;
a reflective element, operatively coupled to the base and disposed opposite the substantially non-reflective rear facet to form an external cavity; and
a tunable filter including at least one optical element operatively coupled to the base and disposed in the external cavity.

26. The tunable ECDL of claim 25, wherein the partially-reflective in-waveguide mirror is effectuated by a high-aspect ratio cut passing through a waveguide core in the mirror section and disposed substantially perpendicular to a longitudinal axis passing through the waveguide core.

27. The tunable ECDL of claim 25, wherein the partially-reflective in-waveguide mirror is effectuated by a one or more low-aspect ratio gaps passing through a waveguide core in the mirror section, said one or more low-aspect ratio gaps being backfilled with a backfill material having an index of refraction differing from an index of refraction of the waveguide core.

28. The tunable ECDL of claim 27, wherein one of the trenches is etched at an angle relative to a centerline of the waveguide core proximate to the trench, the trench when backfilled functioning as an angled mirror that is used to split-off a portion of an optical beam passing through the waveguide during operation of the apparatus, further including:
a photo-electric device, optically-coupled to the angled mirror to receive a split-off portion of the optical beam.

29. The tunable ECDL of claim 28, wherein the photo-electric device is built-into the integrated structure.

30. The tunable ECDL of claim 25, wherein bandgaps of portions of the waveguide passing through the phase control and modulator sections are broadened approximately 0.06-0.12 eV (electron-volts) relative to a bandgap of the portion of the waveguide passing through the gain section.

31. The tunable ECDL of claim 25, further comprising a controller to supply control inputs to the gain section, phase control section, and the tunable filter.

32. The tunable ECDL of claim 25, wherein the tunable filter comprises first and second tunable filters.

33. The tunable ECDL of claim 32, wherein each of the first and second tunable filters comprises thermally-tunable etalons, and the controller provides inputs to control the temperature of each thermally-tunable etalon.

34. The tunable ECDL of claim 25, wherein the tunable filter comprises a Vernier tuning mechanism including respective first and second optical filters having respective sets of transmission peaks having slightly different free spectral ranges and similar finesses, and wherein tuning is performed by shifting the set of transmission peaks of the second optical filter relative to the set of transmission peaks of first optical filter to align a single transmission peak of each of the first and second sets of transmission peaks.

35. The tunable ECDL of claim 25, wherein the gain medium section is disposed between the phase control section and the mirror section, the phase control section having an external facet defining the substantially non-reflective rear facet.

36. The tunable ECDL of claim 25, wherein the phase control section is disposed between the gain medium and the mirror section, the gain medium section having an external facet defining the substantially non-reflective rear facet.

37. A telecommunication switch comprising:
a plurality of fiber line cards, each including,
a multi-stage multiplexer/demultiplexer;
a circulator bank, comprising a plurality of circulators operatively coupled to the multi-stage multiplexer/demultiplexer;
a receiver bank, comprising a plurality of receivers operatively coupled to respective circulators; and
a transmitter bank, comprising a plurality of transmitters operatively coupled to respective circulators, each transmitter comprising at tunable external cavity diode laser (ECDL), including:
a base;
an integrated structure operatively coupled to the base, having a substantially non-reflective front facet and rear facet optically coupled via a waveguide passing therethrough, the integrated structure further including:
a gain section to emit a plurality of photons in response to a first electrical input,
a phase control section disposed adjacent to the gain section, to modulate an optical path length of a portion of the waveguide passing through the phase control section in response to a second electrical input;
a modulator section, optically coupled to the gain section and phase control section via a portion of the waveguide, to modulate an optical output generated by the tunable laser passing through a portion of the waveguide disposed in the modulator section in response to a third electrical input, and having a facet defining the front facet of the integrated structure; and
a partially-reflective mirror formed within a mirror section comprising the portion of the waveguide disposed between the modulator section and one of the gain section and phase control section;
a reflective element, operatively coupled to the base and disposed opposite the substantially non-reflective rear facet to form an external cavity; and
a tunable filter including at least one optical element operatively coupled to the base and disposed in the external cavity.

38. The telecommunication switch of claim 37, wherein at least one ECDL employs a Vernier tuning mechanism including respective first and second optical filters having respective sets of transmission peaks having slightly different free spectral ranges and similar finesses, and wherein tuning is performed by shifting the set of transmission peaks of the second optical filter relative to the set of transmission peaks of first optical filter to align a single transmission peak of each of the first and second sets of transmission peaks.

39. The telecommunication switch of claim 38, wherein the first and second optical filters comprise respective thermally-tunable etalons.

40. A method, comprising:
fabricating an integrated structure including a waveguide passing therethrough, at least a portion of the waveguide having a ridge waveguide structure, the waveguide having a waveguide core; and
defining an in-waveguide mirror in a portion of the waveguide by cutting the ridge through to the waveguide core using a focused ion beam to form a high-aspect ratio gap through the waveguide core.

41. The method of claim 40, wherein the waveguide core of the integrated structure is formed from an InGaAsP (Indium-Gallium-Arsenic-Phosphorus)-based semiconductor material.

42. The method of claim 40, wherein the operation of fabricating the integrated structure further includes fabricating a gain section, mirror section, and modulator section, each of which is optically coupled to an adjacent section via the waveguide passing therethrough, the mirror section containing the portion of the waveguide in which the in-waveguide mirror is defined.

43. A method, comprising:
fabricating an integrated structure having a waveguide passing therethrough, the waveguide having a waveguide core;
defining one or more trenches through the waveguide core in a portion of the waveguide; and
backfilling the one or more trenches with a backfill material having a different index of refraction than the waveguide core.

44. The method of claim 43, wherein the one or more trenches are backfilled by re-growing a crystalline structure.

45. The method of claim 43, wherein the one or more trenches are backfilled with an amorphous material.
